(19) United States
(12) Patent Application Publication
(10) Pub. No.: US 2021/0188043 A1
(43) Pub. Date: Jun. 24, 2021

(54) THERMAL MANAGEMENT SYSTEM TOPOLOGY WITH CASCADED REFRIGERANT AND COOLANT CIRCUITS

(71) Applicant: NIO USA, Inc., San Jose, CA (US)

(72) Inventors: Joshua Smith, Los Gatos, CA (US); Dewashish Kanta Prashad, San Jose, CA (US); Armando Mendez Abrego, Sunnyvale, CA (US)

(21) Appl. No.: 16/725,223

(22) Filed: Dec. 23, 2019

(51) Int. Cl. B60H 1/22; B60H 1/00; B60H 1/32

(52) U.S. Cl. CPC B60H 1/2218; B60H 1/00007; B60H 1/00278; B60H 1/00385; B60H 2001/00307; B60H 1/3204; B60H 1/323; B60H 2001/003; B60H 1/00428

(57) ABSTRACT

A thermal management system comprises a coolant system and a separate refrigerant system that are both selectively interconnectable to a chiller. The coolant system includes a radiator and a plurality of fluid lines forming a selectable interconnectable array of coolant loops. This array includes an energy storage system coolant loop and an electrical drive system coolant loop that are separately interconnectable with the radiator and that control the temperature of the energy storage system and the electrical drive system of an electric vehicle. The refrigerant system includes a condenser, an internal heat exchanger, and an array of refrigerant loops that control the temperature of a cabin of the electric vehicle. Together, the coolant system and the refrigerant system provide multiple thermal control modes for components of an electric vehicle.

### FIELD

The present disclosure is generally directed toward vehicle thermal management systems, and more particularly, toward thermal management systems for electric and/or hybrid-electric vehicles.

### BACKGROUND

The thermal system topology is deployed in a vehicle to maintain temperature of powertrain components within specified limits and to facilitate ambient cabin comfort. Unlike internal combustion engine vehicles, electric vehicles are very sensitive to thermal and electrical usage for auxiliary systems and cabin comfort.

### BRIEF DESCRIPTION OF THE DRAWINGS

FIG. 1 shows a vehicle in accordance with embodiments of the present disclosure;

FIG. 2 shows a bottom plan view of the vehicle in accordance with at least some embodiments of the present disclosure;

FIG. 3 shows a top plan view of the vehicle in accordance with embodiments of the present disclosure;

FIG. 4A is a block diagram illustrating a first portion of a communication environment of the vehicle in accordance with embodiments of the present disclosure;

FIG. 4B is a block diagram illustrating a second portion of a communication environment of the vehicle in accordance with embodiments of the present disclosure;

FIG. 5 is a diagram of a thermal management system in accordance with embodiments of the present disclosure;

FIG. 6A is a diagram of the thermal management system of FIG. 5 in a first cooling mode in accordance with embodiments of the present disclosure;

FIG. 6B is a diagram of the thermal management system of FIG. 5 in a second cooling mode in accordance with embodiments of the present disclosure;

FIG. 6C is a diagram of the thermal management system of FIG. 5 in a first pump failure mode in accordance with embodiments of the present disclosure;

FIG. 6D is a diagram of the thermal management system of FIG. 5 in a second pump failure mode in accordance with embodiments of the present disclosure;

FIG. 7A is a diagram of the thermal management system of FIG. 5 in a first heating mode in accordance with embodiments of the present disclosure;

FIG. 7B is a diagram of the thermal management system of FIG. 5 in a second heating mode in accordance with embodiments of the present disclosure;

FIG. 7C is a diagram of the thermal management system of FIG. 5 in a third heating mode in accordance with embodiments of the present disclosure;

FIG. 7D is a diagram of the thermal management system of FIG. 5 in a first dehumidification mode in accordance with embodiments of the present disclosure;

FIG. 7E is a diagram of the thermal management system of FIG. 5 in a second dehumidification mode in accordance with embodiments of the present disclosure;

FIG. 7F is a diagram of the thermal management system of FIG. 5 in a third dehumidification mode in accordance with embodiments of the present disclosure;

FIG. 7G is a diagram of the thermal management system of FIG. 5 in a heat pump mode in accordance with embodiments of the present disclosure;

FIG. 8A is a diagram of the thermal management system of FIG. 5 in a first deicing mode in accordance with embodiments of the present disclosure;

FIG. 8B is a diagram of the thermal management system of FIG. 5 in a second deicing mode in accordance with embodiments of the present disclosure; and

FIG. 8C is a diagram of the thermal management system of FIG. 5 in a third deicing mode in accordance with embodiments of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

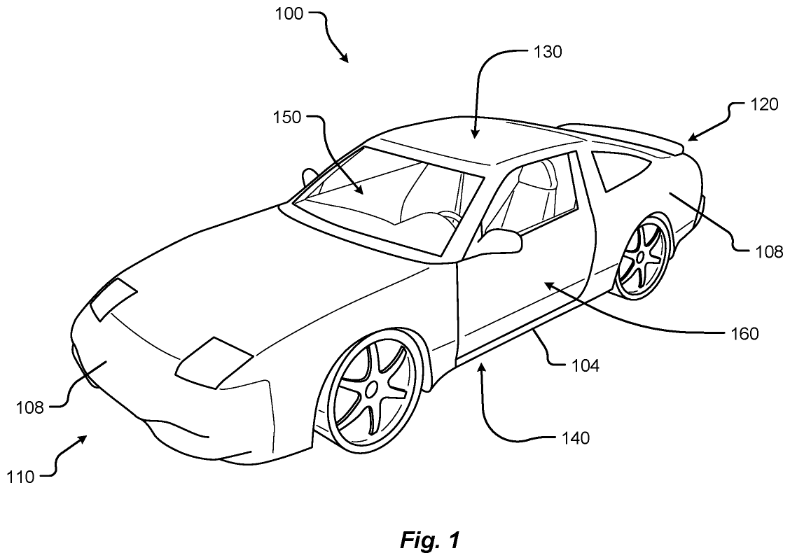

FIG. 1 shows a perspective view of a vehicle 100 (e.g., an electric vehicle, etc.) in accordance with embodiments of the present disclosure. The vehicle 100 comprises a vehicle front 110, vehicle aft 120, vehicle roof 130, at least one vehicle side 160, a vehicle undercarriage 140, and a vehicle interior or cabin 150. In any event, the vehicle 100 may include a frame 104 and one or more body panels 108 mounted or affixed thereto. The vehicle 100 may include one or more interior components (e.g., components inside an interior space or cabin 150, or user space, of a vehicle 100, etc.), exterior components (e.g., components outside of the interior space or cabin 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

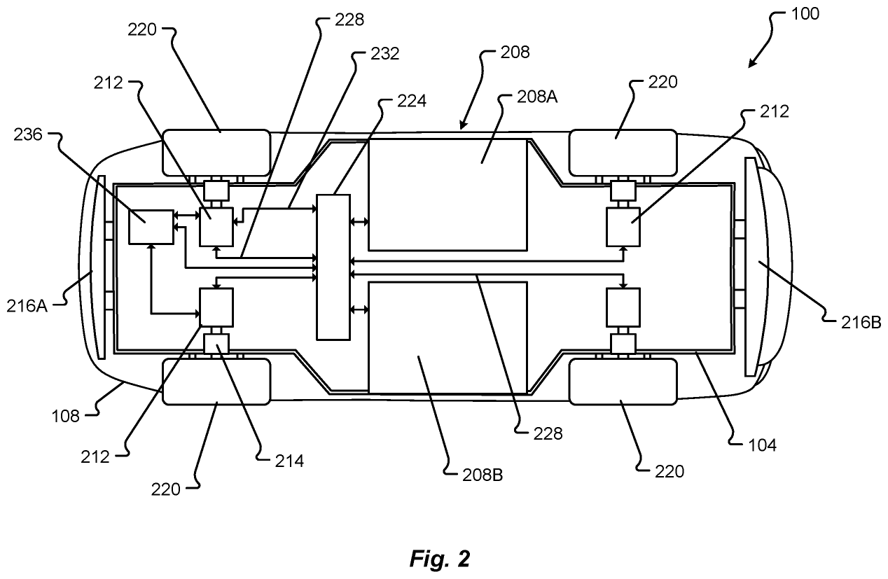

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be, for example, formed, welded, fused, fastened, pressed, combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allows the vehicle 100 to adapt to the ever-changing technological demands of society and advances in safety. Among other things, the mechanisms may provide for the quick exchange of, for example, batteries, capacitors, power sources 208A, 208B (e.g., energy storage systems, etc.), motors 212, engines, safety equipment, controllers, user interfaces, interior or exterior components, body panels 108, bumpers 216, sensors, and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, for example, the frame 104 may include slides, receptacles, cavities, protrusions, and/or a number of other features that allow for quick exchange of system components. In one embodiment, the frame 104 may include, for example, tray or ledge features, mechanical interconnection features, locking mechanisms, retaining mechanisms, and/or combinations thereof. In some embodiments, it may be beneficial to quickly remove a used power source 208A, 208B (e.g., battery unit, capacitor unit) from the vehicle 100 and replace the used power source 208A, 208B with a charged or new power source. Continuing this example, the power source 208A, 208B may include selectively interchangeable features that interconnect with the frame 104 or other portion of the vehicle 100. For instance, in a power source 208A, 208B replacement, the quick release features may be configured to release the power source 208A, 208B from an engaged position and slide or move in a direction away from the frame 104 of a vehicle 100. Once removed, or separated from, the vehicle, the power source 208A, 208B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured, for example, as electromagnetic mechanisms, mechanical couplings, electromechanical coupling mechanisms, and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allows one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 includes one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption of power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored, for example, as mechanical movement (e.g., in a flywheel, etc.) and electrical energy may be stored, for example, in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

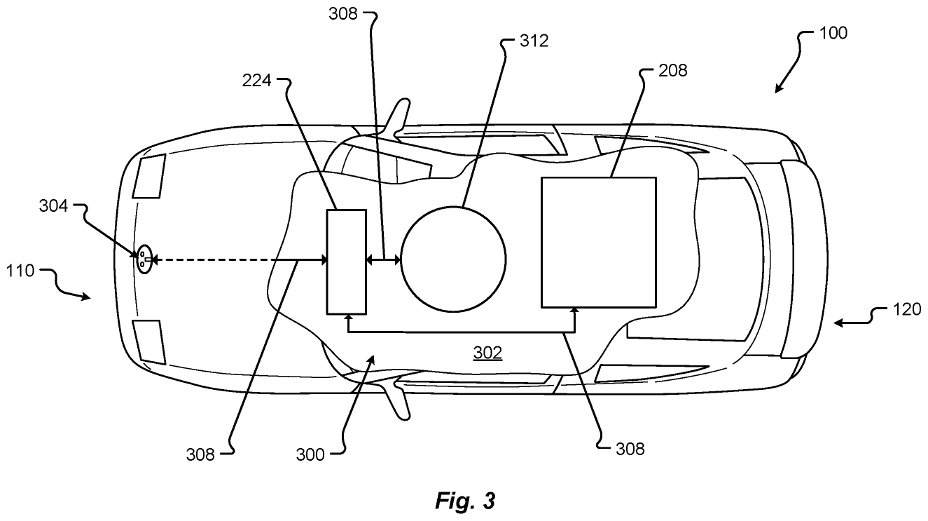

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

The vehicle sensors and systems may be selected and/or configured to suit a level of operation associated with the vehicle 100. Among other things, the number of sensors used in a system may be altered to increase or decrease information available to a vehicle control system (e.g., affecting control capabilities of the vehicle 100). Additionally or alternatively, the sensors and systems may be part of one or more advanced driver assistance systems (ADAS) associated with a vehicle 100. In any event, the sensors and systems may be used to provide driving assistance at any level of operation (e.g., from fully-manual to fully-autonomous operations, etc.) as described herein.

The various levels of vehicle control and/or operation can be described as corresponding to a level of autonomy associated with a vehicle 100 for vehicle driving operations. For instance, at Level 0, or fully-manual driving operations, a driver (e.g., a human driver) may be responsible for all the driving control operations (e.g., steering, accelerating, braking, etc.) associated with the vehicle. Level 0 may be referred to as a “No Automation” level. At Level 1, the vehicle may be responsible for a limited number of the driving operations associated with the vehicle, while the driver is still responsible for most driving control operations. An example of a Level 1 vehicle may include a vehicle in which the throttle control and/or braking operations may be controlled by the vehicle (e.g., cruise control operations, etc.). Level 1 may be referred to as a “Driver Assistance” level. At Level 2, the vehicle may collect information (e.g., via one or more driving assistance systems, sensors, etc.) about an environment of the vehicle (e.g., surrounding area, roadway, traffic, ambient conditions, etc.) and use the collected information to control driving operations (e.g., steering, accelerating, braking, etc.) associated with the vehicle. In a Level 2 autonomous vehicle, the driver may be required to perform other aspects of driving operations not controlled by the vehicle. Level 2 may be referred to as a “Partial Automation” level. It should be appreciated that Levels 0-2 all involve the driver monitoring the driving operations of the vehicle.

At Level 3, the driver may be separated from controlling all the driving operations of the vehicle except when the vehicle makes a request for the operator to act or intervene in controlling one or more driving operations. In other words, the driver may be separated from controlling the vehicle unless the driver is required to take over for the vehicle. Level 3 may be referred to as a “Conditional Automation” level. At Level 4, the driver may be separated from controlling all the driving operations of the vehicle and the vehicle may control driving operations even when a user fails to respond to a request to intervene. Level 4 may be referred to as a “High Automation” level. At Level 5, the vehicle can control all the driving operations associated with the vehicle in all driving modes. The vehicle in Level 5 may continually monitor traffic, vehicular, roadway, and/or environmental conditions while driving the vehicle. In Level 5, there is no human driver interaction required in any driving mode. Accordingly, Level 5 may be referred to as a “Full Automation” level. It should be appreciated that in Levels 3-5 the vehicle, and/or one or more automated driving systems associated with the vehicle, monitors the driving operations of the vehicle and the driving environment.

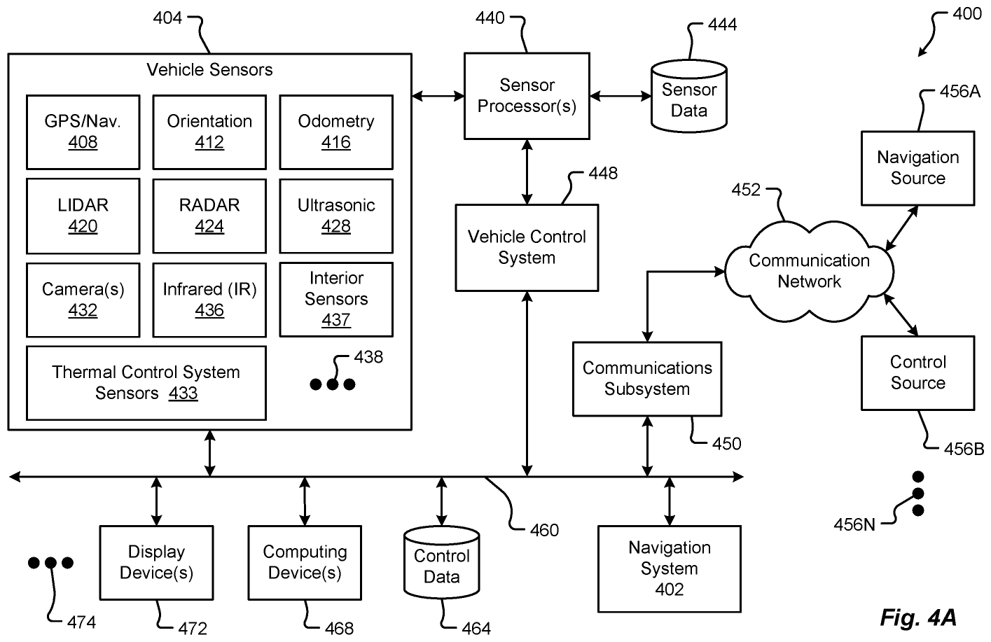

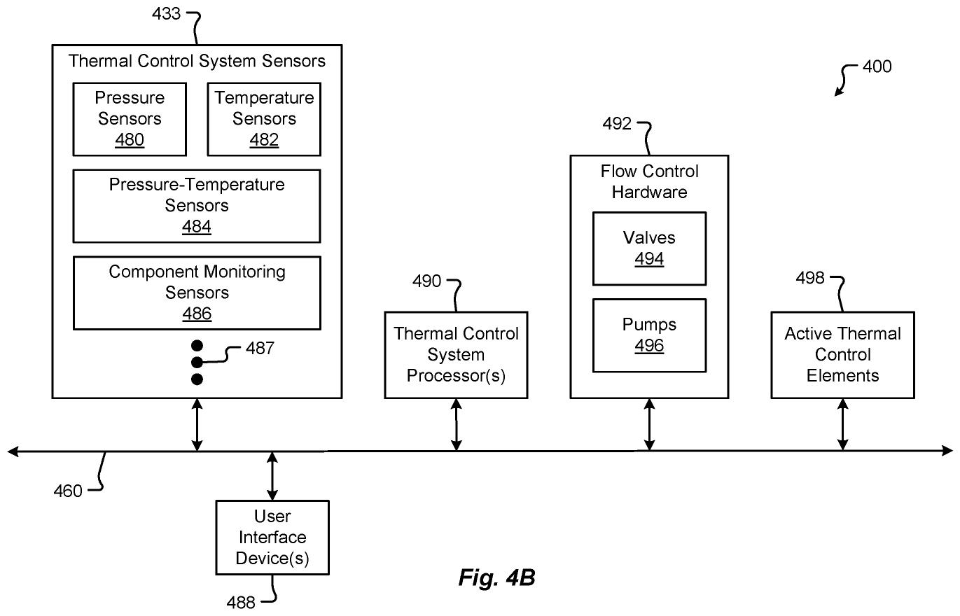

FIG. 4A is a block diagram illustrating a first portion of a communication environment 400 of the vehicle 100 in accordance with embodiments of the present disclosure. The communication system 400 may include one or more vehicle sensors and systems 404, sensor processors 440, sensor data memory 444, vehicle control system 448, communications subsystem 450, control data 464, computing devices 468, display devices 472, and other components 474 that may be associated with a vehicle 100. These associated components may be electrically and/or communicatively coupled to one another via at least one bus 460. In some embodiments, the one or more associated components may send and/or receive signals across a communication network 452 to at least one of a navigation source 456A, a control source 456B, or some other entity 456N.

In accordance with at least some embodiments of the present disclosure, the communication network 452 may comprise any type of known communication medium or collection of communication media and may use any type of protocols, such as SIP, TCP/IP, SNA, IPX, AppleTalk, and the like, to transport messages between endpoints. The communication network 452 may include wired and/or wireless communication technologies. The Internet is an example of the communication network 452 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), such as an Ethernet network, a Token-Ring network and/or the like, a Wide Area Network (WAN), a virtual network, including without limitation a virtual private network (“VPN”); the Internet, an intranet, an extranet, a cellular network, an infra-red network; a wireless network (e.g., a network operating under any of the IEEE 802.9 suite of protocols, the Bluetooth® protocol known in the art, and/or any other wireless protocol), and any other type of packet-switched or circuit-switched network known in the art and/or any combination of these and/or other networks. In addition, it can be appreciated that the communication network 452 need not be limited to any one network type, and instead may be comprised of a number of different networks and/or network types. The communication network 452 may comprise a number of different communication media such as coaxial cable, copper cable/wire, fiber-optic cable, antennas for transmitting/receiving wireless messages, and combinations thereof.

The vehicle sensors and systems 404 may include at least one navigation 408 (e.g., global positioning system (GPS), etc.), orientation 412, odometry 416, LIDAR 420, RADAR 424, ultrasonic 428, camera 432, thermal control system sensors 433, infrared (IR) 436, interior 437, and/or other sensor or system 438.

The navigation sensor 408 may include one or more sensors having receivers and antennas that are configured to utilize a satellite-based navigation system including a network of navigation satellites capable of providing geolocation and time information to at least one component of the vehicle 100. Examples of the navigation sensor 408 as described herein may include, but are not limited to, at least one of Garmin® GLO™ family of GPS and GLONASS combination sensors, Garmin® GPS 15x™ family of sensors, Garmin® GPS 16x™ family of sensors with high-sensitivity receiver and antenna, Garmin® GPS 18x OEM family of high-sensitivity GPS sensors, Dewetron DEWE-VGPS series of GPS sensors, GlobalSat 1-Hz series of GPS sensors, other industry-equivalent navigation sensors and/or systems, and may perform navigational and/or geolocation functions using any known or future-developed standard and/or architecture.

The orientation sensor 412 may include one or more sensors configured to determine an orientation of the vehicle 100 relative to at least one reference point. In some embodiments, the orientation sensor 412 may include at least one pressure transducer, stress/strain gauge, accelerometer, gyroscope, and/or geomagnetic sensor. Examples of the navigation sensor 408 as described herein may include, but are not limited to, at least one of Bosch Sensortec BMX 160 series low-power absolute orientation sensors, Bosch Sensortec BMX055 9-axis sensors, Bosch Sensortec BMI055 6-axis inertial sensors, Bosch Sensortec BMI160 6-axis inertial sensors, Bosch Sensortec BMF055 9-axis inertial sensors (accelerometer, gyroscope, and magnetometer) with integrated Cortex M0+ microcontroller, Bosch Sensortec BMP280 absolute barometric pressure sensors, Infineon TLV493D-A1B6 3D magnetic sensors, Infineon TLI493D-W1B6 3D magnetic sensors, Infineon TL family of 3D magnetic sensors, Murata Electronics SCC2000 series combined gyro sensor and accelerometer, Murata Electronics SCC1300 series combined gyro sensor and accelerometer, other industry-equivalent orientation sensors and/or systems, which may perform orientation detection and/or determination functions using any known or future-developed standard and/or architecture.

The odometry sensor and/or system 416 may include one or more components configured to determine a change in position of the vehicle 100 over time. In some embodiments, the odometry system 416 may utilize data from one or more other sensors and/or systems 404 in determining a position (e.g., distance, location, etc.) of the vehicle 100 relative to a previously measured position for the vehicle 100. Additionally or alternatively, the odometry sensors 416 may include one or more encoders, Hall speed sensors, and/or other measurement sensors/devices configured to measure a wheel speed, rotation, and/or number of revolutions made over time. Examples of the odometry sensor/system 416 as described herein may include, but are not limited to, at least one of Infineon TLE4924/26/27/28C high-performance speed sensors, Infineon TL4941plusC(B) single chip differential Hall wheel-speed sensors, Infineon TL5041plusC Giant Magnetoresistance (GMR) effect sensors, Infineon TL family of magnetic sensors, EPC Model 25SP Accu-CoderPro™ incremental shaft encoders, EPC Model 30M compact incremental encoders with advanced magnetic sensing and signal processing technology, EPC Model 925 absolute shaft encoders, EPC Model 958 absolute shaft encoders, EPC Model MA36S/MA63S/SA36S absolute shaft encoders, Dynapar™ F18 commutating optical encoder, Dynapar™ HS35R family of phased array encoder sensors, other industry-equivalent odometry sensors and/or systems, and may perform change in position detection and/or determination functions using any known or future-developed standard and/or architecture.

The LIDAR sensor/system 420 may include one or more components configured to measure distances to targets using laser illumination. In some embodiments, the LIDAR sensor/system 420 may provide 3D imaging data of an environment around the vehicle 100. The imaging data may be processed to generate a full 360-degree view of the environment around the vehicle 100. The LIDAR sensor/system 420 may include a laser light generator configured to generate a plurality of target illumination laser beams (e.g., laser light channels). In some embodiments, this plurality of laser beams may be aimed at, or directed to, a rotating reflective surface (e.g., a mirror) and guided outwardly from the LIDAR sensor/system 420 into a measurement environment. The rotating reflective surface may be configured to continually rotate 360 degrees about an axis, such that the plurality of laser beams is directed in a full 360-degree range around the vehicle 100. A photodiode receiver of the LIDAR sensor/system 420 may detect when light from the plurality of laser beams emitted into the measurement environment returns (e.g., reflected echo) to the LIDAR sensor/system 420. The LIDAR sensor/system 420 may calculate, based on a time associated with the emission of light to the detected return of light, a distance from the vehicle 100 to the illuminated target. In some embodiments, the LIDAR sensor/system 420 may generate over 2.0 million points per second and have an effective operational range of at least 100 meters. Examples of the LIDAR sensor/system 420 as described herein may include, but are not limited to, at least one of Velodyne® LiDAR™ HDL-64E 64-channel LIDAR sensors, Velodyne® LiDAR™ HDL-32E 32-channel LIDAR sensors, Velodyne® LiDAR™ PUCK™ VLP-16 16-channel LIDAR sensors, Leica Geosystems Pegasus:Two mobile sensor platform, Garmin® LIDAR-Lite v3 measurement sensor, Quanergy M8 LiDAR sensors, Quanergy S3 solid state LiDAR sensor, LeddarTech® LeddarVU compact solid state fixed-beam LIDAR sensors, other industry-equivalent LIDAR sensors and/or systems, and may perform illuminated target and/or obstacle detection in an environment around the vehicle 100 using any known or future-developed standard and/or architecture.

The RADAR sensors 424 may include one or more radio components that are configured to detect objects/targets in an environment of the vehicle 100. In some embodiments, the RADAR sensors 424 may determine a distance, position, and/or movement vector (e.g., angle, speed, etc.) associated with a target over time. The RADAR sensors 424 may include a transmitter configured to generate and emit electromagnetic waves (e.g., radio, microwaves, etc.) and a receiver configured to detect returned electromagnetic waves. In some embodiments, the RADAR sensors 424 may include at least one processor configured to interpret the returned electromagnetic waves and determine locational properties of targets. Examples of the RADAR sensors 424 as described herein may include, but are not limited to, at least one of Infineon RASIC™ RTN7735PL transmitter and RRN7745PL/46PL receiver sensors, Autoliv ASP Vehicle RADAR sensors, Delphi L2C0051TR 77 GHz ESR Electronically Scanning Radar sensors, Fujitsu Ten Ltd. Automotive Compact 77 GHz 3D Electronic Scan Millimeter Wave Radar sensors, other industry-equivalent RADAR sensors and/or systems, and may perform radio target and/or obstacle detection in an environment around the vehicle 100 using any known or future-developed standard and/or architecture.

The ultrasonic sensors 428 may include one or more components that are configured to detect objects/targets in an environment of the vehicle 100. In some embodiments, the ultrasonic sensors 428 may determine a distance, position, and/or movement vector (e.g., angle, speed, etc.) associated with a target over time. The ultrasonic sensors 428 may include an ultrasonic transmitter and receiver, or transceiver, configured to generate and emit ultrasound waves and interpret returned echoes of those waves. In some embodiments, the ultrasonic sensors 428 may include at least one processor configured to interpret the returned ultrasonic waves and determine locational properties of targets. Examples of the ultrasonic sensors 428 as described herein may include, but are not limited to, at least one of Texas Instruments TIDA-00151 automotive ultrasonic sensor interface IC sensors, MaxBotix® MB8450 ultrasonic proximity sensor, MaxBotix® ParkSonar™-EZ ultrasonic proximity sensors, Murata Electronics MA40H1S-R open-structure ultrasonic sensors, Murata Electronics MA40S4R/S open-structure ultrasonic sensors, Murata Electronics MA58MF14-7N waterproof ultrasonic sensors, other industry-equivalent ultrasonic sensors and/or systems, and may perform ultrasonic target and/or obstacle detection in an environment around the vehicle 100 using any known or future-developed standard and/or architecture.

The camera sensors 432 may include one or more components configured to detect image information associated with an environment of the vehicle 100. In some embodiments, the camera sensors 432 may include a lens, filter, image sensor, and/or a digital image processer. It is an aspect of the present disclosure that multiple camera sensors 432 may be used together to generate stereo images providing depth measurements. Examples of the camera sensors 432 as described herein may include, but are not limited to, at least one of ON Semiconductor® MT9V024 Global Shutter VGA GS CMOS image sensors, Teledyne DALSA Falcon2 camera sensors, CMOSIS CMV50000 high-speed CMOS image sensors, other industry-equivalent camera sensors and/or systems, and may perform visual target and/or obstacle detection in an environment around the vehicle 100 using any known or future-developed standard and/or architecture.

The infrared (IR) sensors 436 may include one or more components configured to detect image information associated with an environment of the vehicle 100. The IR sensors 436 may be configured to detect targets in low-light, dark, or poorly-lit environments. The IR sensors 436 may include an IR light emitting element (e.g., IR light emitting diode (LED), etc.) and an IR photodiode. In some embodiments, the IR photodiode may be configured to detect returned IR light at or about the same wavelength to that emitted by the IR light emitting element. In some embodiments, the IR sensors 436 may include at least one processor configured to interpret the returned IR light and determine locational properties of targets. The IR sensors 436 may be configured to detect and/or measure a temperature associated with a target (e.g., an object, pedestrian, other vehicle, etc.). Examples of IR sensors 436 as described herein may include, but are not limited to, at least one of Opto Diode lead-salt IR array sensors, Opto Diode OD-850 Near-IR LED sensors, Opto Diode SA/SHA727 steady state IR emitters and IR detectors, FLIR® LS microbolometer sensors, FLIR® TacFLIR 380-HD InSb MWIR FPA and HD MWIR thermal sensors, FLIR® VOx 640×480 pixel detector sensors, Delphi IR sensors, other industry-equivalent IR sensors and/or systems, and may perform IR visual target and/or obstacle detection in an environment around the vehicle 100 using any known or future-developed standard and/or architecture.

The interior sensors 437 may include passenger compartment temperature sensors (utilized, e.g., in connection with a vehicle climate control system), passenger compartment occupancy sensors (utilized, e.g., in connection with vehicle safety systems, including passive and active restraint systems); wheel-speed sensors (utilized, e.g., in connection with an anti-lock braking system and/or an electronic traction control system); door sensors (utilized, e.g., to communicate to a vehicle operator whether the vehicle doors are locked or unlocked, and/or open or closed); light sensors (utilized, e.g., to automatically adjust the brightness of instrument panel lighting); electronic system temperature sensors (utilized, e.g., to determine whether vehicle electronic systems are within appropriate operating temperature ranges, and, in some embodiments, to enable a vehicle cooling system to route coolant to electronic systems within the vehicle that are most in need of cooling); coolant temperature sensors (utilized, e.g., to facilitate efficient vehicle thermal management); and pressure-temperature transducers (also utilized, e.g., to facilitate efficient vehicle thermal management).

A navigation system 402 can include any hardware and/or software used to navigate the vehicle either manually or autonomously.

In some embodiments, the driving vehicle sensors and systems 404 may include other sensors 438 and/or combinations of the sensors 408-437 described above. Additionally or alternatively, one or more of the sensors 408-437 described above may include one or more processors or controllers configured to process and/or interpret signals detected by the one or more sensors 408-437. In some embodiments, the processing of at least some sensor information provided by the vehicle sensors and systems 404 may be processed by at least one sensor processor 440. Raw and/or processed sensor data may be stored in a sensor data memory 444 storage medium. In some embodiments, the sensor data memory 444 may store instructions used by the sensor processor 440 for processing sensor information provided by the sensors and systems 404. In any event, the sensor data memory 444 may be a disk drive, optical storage device, solid-state storage device such as a random-access memory (“RAM”) and/or a read-only memory (“ROM”), which can be programmable, flash-updateable, and/or the like.

The vehicle control system 448 may receive processed sensor information from the sensor processor 440 and determine to control an aspect of the vehicle 100. Controlling an aspect of the vehicle 100 may include presenting information via one or more display devices 472 associated with the vehicle, sending commands to one or more computing devices 468 associated with the vehicle, and/or controlling a driving operation of the vehicle. In some embodiments, the vehicle control system 448 may correspond to one or more computing systems that control driving operations of the vehicle 100 in accordance with the Levels of driving autonomy described above. In one embodiment, the vehicle control system 448 may operate a speed of the vehicle 100 by controlling an output signal to the accelerator and/or braking system of the vehicle. In this example, the vehicle control system 448 may receive sensor data describing an environment surrounding the vehicle 100 and, based on the sensor data received, determine to adjust the acceleration, power output, and/or braking of the vehicle 100. The vehicle control system 448 may additionally control steering and/or other driving functions of the vehicle 100.

The vehicle control system 448 may communicate, in real-time, with the driving sensors and systems 404 forming a feedback loop. In particular, upon receiving sensor information describing a condition of targets in the environment surrounding the vehicle 100, the vehicle control system 448 may autonomously make changes to a driving operation of the vehicle 100. The vehicle control system 448 may then receive subsequent sensor information describing any change to the condition of the targets detected in the environment as a result of the changes made to the driving operation. This continual cycle of observation (e.g., via the sensors, etc.) and action (e.g., selected control or non-control of vehicle operations, etc.) allows the vehicle 100 to operate autonomously in the environment.

In some embodiments, the one or more components of the vehicle 100 (e.g., the driving vehicle sensors 404, vehicle control system 448, display devices 472, etc.) may communicate across the communication network 452 to one or more entities 456A-N via a communications subsystem 450 of the vehicle 100. For instance, the navigation sensors 408 may receive global positioning, location, and/or navigational information from a navigation source 456A. In some embodiments, the navigation source 456A may be a global navigation satellite system (GNSS) similar, if not identical, to NAVSTAR GPS, GLONASS, EU Galileo, and/or the BeiDou Navigation Satellite System (BDS) to name a few.

In some embodiments, the vehicle control system 448 may receive control information from one or more control sources 456B. The control source 456 may provide vehicle control information including autonomous driving control commands, vehicle operation override control commands, and the like. The control source 456 may correspond to an autonomous vehicle control system, a traffic control system, an administrative control entity, and/or some other controlling server. It is an aspect of the present disclosure that the vehicle control system 448 and/or other components of the vehicle 100 may exchange communications with the control source 456 across the communication network 452 and via the communications subsystem 450.

Information associated with controlling driving operations of the vehicle 100 may be stored in a control data memory 464 storage medium. The control data memory 464 may store instructions used by the vehicle control system 448 for controlling driving operations of the vehicle 100, historical control information, autonomous driving control rules, and the like. In some embodiments, the control data memory 464 may be a disk drive, optical storage device, solid-state storage device such as a random-access memory (“RAM”) and/or a read-only memory (“ROM”), which can be programmable, flash-updateable, and/or the like.

Referring to FIG. 4B, a block diagram illustrating a second portion of a communication system 400 of the vehicle 100 is shown in accordance with embodiments of the present disclosure. The communication system 400 may comprise one or more components, devices, systems, and interfaces that are associated with the thermal management system of the vehicle 100. For instance, the communication system, as shown in FIG. 4B, may comprise the thermal control system sensors 433, the user interface device(s) 488, one or more thermal control system processors 490, flow control hardware 492, active thermal control elements 498, and/or the like. The various components shown in FIG. 4B may be in communication with one another and/or in communication with the components illustrated in FIG. 4A (e.g., via the bus 460, etc.). The bus 460 may be configured as a power and/or a communications bus.

The thermal control system sensors 433 may comprise pressure sensors 480, temperature sensors 482, combination pressure-temperature sensors 484, component monitoring sensors 486, and/or other measurement/monitoring sensors 487.

The pressure sensors 480 may include, but are in no way limited to, absolute pressure sensors (e.g., where a first side of the sensor is exposed to the fluid to be measured and where the second, opposite, side of the sensor is sealed, etc.), differential pressure sensors (e.g., where the difference between two points disposed on opposite sides of the sensor are measured, etc.), gauge pressure sensors (e.g., where a pressure measurement is made relative to atmosphere or some other known local pressure, etc.), pressure transducers, combinations thereof, and/or the like. The pressure measured and/or reported by the pressure sensors 480 may be represented in units of force per unit of surface area, such as, pounds per square inch (PSI), pascals (Pa) or Newtons per square meter (N/m²), kilopascals (kPa), bar, atmospheres (atm), millimeters of mercury (mmHg), etc., and/or the like.

The temperature sensors 482 may include, but are in no way limited to, resistive temperature detectors, thermistors (e.g., positive temperature coefficient (PTC) thermistors, negative temperature coefficient (NTC) thermistors, etc.), thermocouples, thermometers, thermostats, etc., and/or combinations thereof. In some embodiments, the temperature sensors 482 may measure and even report a potential difference between two dissimilar metals that are exposed to a temperature sensing environment. In one embodiment, the temperature sensors 482 may monitor a change in the volume of a fluid that is subjected to a change in temperature (e.g., a mercury or alcohol thermometer, etc.) via a photosensor and a measurement scale or reference.

The pressure-temperature sensors 484 may comprise a combination of one or more of the sensors described in conjunction with the pressure sensors 480 and the temperature sensors 482.

The component monitoring sensors 486 may comprise one or more sensors that measure an operation and/or functionality of one or more components in the thermal management system via optical sensing, mechanical sensing, electrical sensing, etc., and/or various combinations of sensing. For instance, the component monitoring sensors 486 may comprise one or more strain gauge, flow meter, electrical measurement sensor, operatively interconnected with one or more components in the thermal management system. These components may include but are in no way limited to, the thermal control system processors 490, flow control hardware 492, and/or the active thermal control elements 498 in the thermal management system (e.g., the communication environment 400, etc.).

The user interface device(s) 488 may receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. For instance, a user input provided via one or more of the user interface device(s) 488 may, in conjunction with the thermal control system processor(s) 490, control a behavior of the thermal management system. User interfaces may include, but are in no way limited to, at least one graphical user interface of a display device (e.g., touchscreen, etc.), button, switch, lever, smartphone, portable computing touchscreen, communications equipment, etc.

Information measured by the thermal control system sensors 433 and/or input received via the user interface device(s) 488 may be communicated (e.g., via a bus 460) to the thermal control system processor(s) 490. The thermal control system processor(s) 490 may determine based on the information received (e.g., from the thermal control system sensors 433 and/or the user interface device(s) 488, etc.) to control one or more of the flow control hardware 492 and/or the active thermal control elements 498.

The flow control hardware 492 may comprise one or more components that stop, start, change, or otherwise control the flow of fluid (e.g., air, coolant, refrigerant, water, etc.) in the thermal management system. The flow control hardware 492 may comprise one or more valves 494, pumps 496, and/or the like. The valves 494 may include, but are in no way limited to, solenoid valves, pneumatically-actuated valves, expansion valves, thermostatic expansion valves, ball valves, check valves, automatic control valves (e.g., relief valves, flow control valves, back-pressure sustaining valves, pressure control valves, etc.), four-way valves, three-way valves, proportional valves, etc., and/or combinations thereof. In some embodiments, one or more of the valves 494 may be controlled (e.g., opened, closed, flow restricted, etc.) via an electrical signal sent, or output, from the thermal control system processor(s) 490. In some embodiments, the valves 494 may be turned on, off, or otherwise adjusted by the thermal control system processor(s) 490 based on information received from the thermal control system sensors 433, the user interface device(s) 488, and/or a combination thereof.

The pumps 496 may comprise one or more components that mechanical move a fluid (e.g., air, coolant, refrigerant, water, etc.) through one or more pipes, tubes, or other fluid lines in the thermal management system. These pumps 496 may include, but are in no way limited to, centrifugal pumps, gear pumps, peristaltic pumps, positive displacement pumps, reciprocating pumps, rotary pumps, screw pumps, velocity pumps, etc., and/or combinations thereof. The pumps 496 may be controlled via on an electrical signal sent, or output, from the thermal control system processor(s) 490. For instance, the electrical signal may selectively start the pumps 496, stop the pumps 496, alter a speed of the pumps 496, and/or otherwise control an operation of the pumps 496. In some embodiments, the pumps 496 may be turned on, off, or otherwise adjusted by the thermal control system processor(s) 490 based on information received from the thermal control system sensors 433, the user interface device(s) 488, and/or a combination thereof.

In some embodiments, the thermal management system may comprise one or more active thermal control elements 498. Active thermal control elements 498 may include, but are in no way limited to, heaters, condensers, compressors, chillers, air conditioners, accumulators, blowers, fans, evaporators, etc., combinations thereof, and/or the like. The active thermal control elements 498 may be controlled via an electrical signal sent, or output, from the thermal control system processor(s) 490. In one embodiment, the active thermal control elements 498 may be turned on, off, or otherwise adjusted based on information received from the thermal control system sensors 433, the user interface device(s) 488, and/or a combination thereof.

The thermal system topology is deployed in a vehicle 100 to maintain temperature of powertrain components within specified limits and to facilitate ambient cabin comfort. The topology of the thermal management system described herein is designed for an electric vehicle 100 to facilitate battery cooling, car cabin comfort, and cooling all electronic/electrical components of an electric powertrain vehicle (e.g., autonomous driving computer, inverter motor, wireless charger, etc.). The topology is unique with different thermal operation modes respect to heating, cooling, heat pump capability, heat recovery, and failure mode operation.

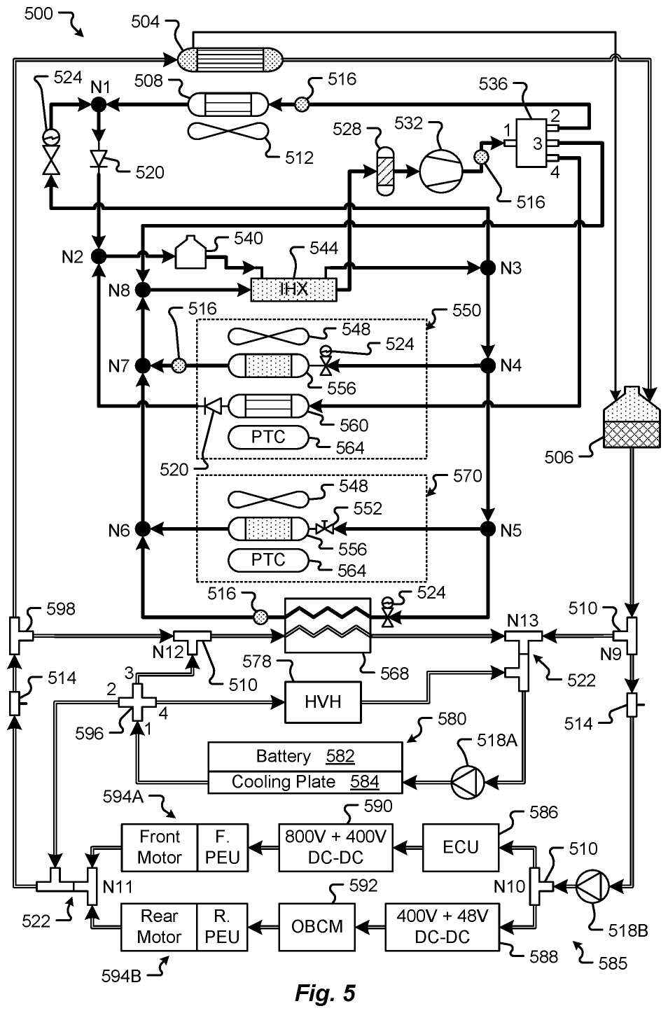

FIG. 5 is a diagram of a thermal management system 500 in accordance with embodiments of the present disclosure. The thermal topology illustrated in the schematic diagram of FIG. 5 is designed to facilitate thermal energy management of a pure electric and/or self-driving electric car. This topology and the associated operational modes comprise coolant loops, refrigerant loops, and combinations thereof, which offer a number of benefits over conventional thermal management systems. For instance, the present disclosure allows coolant waste heat recovery to the refrigerant loop thereby operating the heat pump at lower temperatures (e.g., refrigerant) and then heating the cabin 150 with the refrigerant control loop (e.g., resulting in coefficient of performance gains). Additionally or alternatively, the present disclosure describes a topology that provides an air-to-air (e.g., direct) heat pump (in waste heat mode coolant to refrigerant to air) versus an air-to-coolant (e.g., indirect) heat pump. The present disclosure provides a heat pump mode flow reversal for enhanced performance and/or efficiency. It is an aspect of the present disclosure that either, or both, of the energy storage system (ESS) and/or the electric drive system (EDS) can provide waste heat to the cabin 150 (e.g., together or individually and separately). In some embodiments, the EDS can heat the ESS. As described herein, if the EDS loop pump fails, flow can be reversed to achieve redundancy and allow the ESS loop pump to operate for the EDS loop and the ESS loop. Moreover, the ESS/EDS waste heat recovery and cooling can be controlled either on the refrigerant side (e.g., via an expansion valve, etc.) or on the coolant side (e.g., via a 3-way valve, etc.) for the coolant/refrigerant heat exchange. Other benefits include an optimized topology design having a limited number of pumps and coolant loops, as well as a topology that does not require multiple (e.g., dual) refrigerant-to-coolant heat exchangers and only requires a single component.

As illustrated in FIG. 5, the thermal management system 500 includes a coolant system and a separate refrigeration system. Each system is interconnectable with a chiller 568. In some embodiments, the chiller 568 may exchange heat between the separate systems. The coolant system can control the temperature (e.g., heat and/or cool) of the ESS and/or the EDS and the refrigeration system can control the temperature (e.g., heat and/or cool) of the cabin 150 of the vehicle 100. While each system can be controlled separately, or independently, the coolant system and the refrigerant system may cooperate in controlling the temperature of their respective, or collective, components. In some embodiments, the components of the thermal management system 500 may be controlled with one or more thermal control system processor(s) 490.

The topology of the thermal management system 500 includes the various nodes N1-N13, fluid lines (e.g., shown as double-line arrows and single-line arrows in FIG. 5), valves 510, 536, 596, 598, etc., and components of the coolant system and the refrigerant system. As provided above, the radiator 504 may interconnect with the valve 510 at node N9 via a first fluid flow line, or path. The fluid flow lines, or paths, described herein may correspond to any conduit, pipe, tube, or line that is capable of conveying a fluid (e.g., coolant, refrigerant, water, etc.) from one point to another.

The coolant system may comprise the radiator 504, radiator overflow tank 506, one or more valves 510 (e.g., three-way valves, proportional valves, etc.), one or more temperature sensors 514, an ESS loop (e.g., comprising at least one of the first pump 518A, the battery 582, cooling plate 584, etc.), an EDS loop (e.g., comprising at least one the second pump 518B, the electronic control unit 586, DC-DC converter 588, high-voltage DC-DC converter 590, on-board battery charging module 592, front motor electronics 594A, rear motor electronics 594B, etc.), a first proportional valve 596 (e.g., a four-way valve, etc.), and a plurality of fluid lines connecting the components of the ESS and the EDS with the coolant loop and the radiator 504. As provided above, the coolant system controls the temperature of the ESS and/or the EDS of the vehicle 100.

A fluid flow line may run from the valve 510 at node N9, through the multi-port valve 522 at N13, to the first pump 518A disposed at an inlet side of the ESS 580. In some embodiments, coolant may be directed from the radiator 504 along at least one fluid path toward the radiator overflow tank 506 and the valve 510 at node N9. The valves 510 illustrated in FIG. 5 may correspond to the valves 494 described in conjunction with FIG. 4B, T-joints, and/or the like. For instance, the valve 510 at node N9 may correspond to a three-way valve. In any event, this valve 510 may allow coolant, or a portion thereof, to flow from the radiator 504 toward the multi-port valve 522 disposed at the inlet side of the ESS 580. Additionally or alternatively, the valve 510 may allow coolant, or a portion thereof, to flow from the radiator 504 to the inlet side of the EDS 585. In some embodiments, the valve 510 may operate in at least one reverse condition, where coolant from the EDS 585 passes through the valve 510 toward the multi-port valve 522 at node N13. The multi-port valve 522 may comprise two or more valves 510 that are operatively interconnected with one another. In some embodiments, the multi-port valve 522 may correspond to a four-way, or other proportional, valve. The multi-port valve 522 may correspond to any one or more of the valves 494 described in conjunction with FIG. 4B.

In some embodiments, the first pump 518A may be configured to pump the coolant through the cooling plate 584 to control the temperature of the battery 582 of the vehicle 100. The battery 582 may correspond to one or more of the power sources 208, 208A, 208B described in conjunction with FIGS. 2-3. Once the coolant passes through the ESS 580, the coolant may be directed along a fluid flow line to a proportional valve 596. As shown in FIGS. 5-8C, the proportional valve 596 is configured as a four-way valve. The proportional valve 596 is connected to the fluid line exiting the ESS 580, the fluid line disposed at an exit of the EDS 585, the high-voltage heater 578, and the valve 510 at node N12. The valve 510 at node N12 is disposed at an inlet side of the chiller 568. The proportional valve 596 is shown with each port labeled from 1 to 4. The direction of fluid flow through the proportional valve 596 may be controlled between any combination of ports 1 to 4. In some embodiments, the proportional valve 596 may be controlled to restrict any flow through the valve 596 (e.g., turning the proportional valve 596 to an “off” position). In some embodiments, a portion of the coolant exiting the ESS 580 may be directed to the high-voltage heater 578 along a fluid path extending from port 4 of the proportional valve 596 to the high-voltage heater 578. The high-voltage heater 578 may be fluidly connect to the multi-port valve 522 at node N13 via a fluid line.

Additionally or alternatively, a fluid flow line may run from the valve 510 at node N9 to the second pump 518B disposed at an inlet side of the EDS 585. The inlet side of the EDS 585 may be defined as the side of the EDS 585 adjacent the valve 510 at node N10. In some embodiments, a temperature sensor 514 may be arranged between the valve 510 at node N9 and the second pump 518B. The temperature sensor 514 may correspond to one or more of the temperature sensors 482 described in conjunction with FIG. 4B. This temperature sensor 514 may measure and report a temperature at the inlet side of the EDS 585 to the thermal control system processor(s) 490. Among other things, this measurement may be used by the thermal control system processor(s) 490 in controlling at least one of the flow control hardware 492 and active thermal control elements 498 of the thermal management system 500.

From the valve 510 at node N10, a fluid line may run to a front motor electronics 594A and/or a rear motor electronics 594B. In some embodiments, the fluid lines may be separate and split from the valve 510 at node N10 and reconnect at the multi-port valve 522 at node N11 (e.g., disposed at the exit side of the EDS 585). The fluid line associated with the front motor electronics 594A may be configured to direct at least a portion of coolant along, or through, the electronic control unit 586, and the high-voltage DC-DC converter 59. The fluid line associated with the rear motor electronics 594B may be configured to direct at least a portion of coolant along, or through, the DC-DC converter 588, and the on-board battery charging module 592. The front motor electronics 594A may comprise at least one front motor and a front motor power electronics unit (e.g., F. PEU). The rear motor electronics 594B may comprise at least one rear motor and a rear motor power electronics unit (e.g., R. PEU). As shown and described above, a fluid line from the exit side of the EDS 585 (e.g., adjacent the multi-port valve 522 at node N11) may interconnect with the proportional valve 596 at port 2. In some embodiments, a fluid line may extend from the exit side of the EDS 585 to a loop control valve 598. The loop control valve 598 may be fluidly interconnectable with the chiller 568 along a fluid line and also interconnectable with the radiator 504 along another fluid line. The loop control valve 598 may be controlled by the thermal control system processor(s) 490 to separate at least a portion of the ESS loop and/or the EDS loop from the radiator 504. In some embodiments, a temperature sensor 514 may be arranged between the loop control valve 598 and the multi-port valve 522 at node N11. This temperature sensor 514 may measure and report a temperature at the exit side of the EDS 585 to the thermal control system processor(s) 490. Among other things, this measurement may be used by the thermal control system processor(s) 490 in controlling at least one of the flow control hardware 492 (e.g., the first pump 518A, second pump 518B, loop control valve 598, multi-port valve 522, proportional valve 596, and/or other valve 510, etc.) and the active thermal control elements 498 (e.g., the high-voltage heater 578, etc.) of the thermal management system 500.

The refrigerant system may comprise the condenser 508, blower 512, at least one pressure and temperature sensor 516, a check valve 520, an expansion valve 524, an accumulator 528 (e.g., air conditioning accumulator, etc.), an compressor 532, a multi-port control valve 536, a reservoir 540, an internal heat exchanger 544, at least one fan 548, a thermostatic expansion valve 552, at least one evaporator 556, and positive temperature coefficient heater 564. The refrigerant system may be interconnectable to the chiller 568. The refrigerant system may include a front HVAC system 550 (e.g., configured to control the temperature associated with a front compartment of the cabin 150 of the vehicle 100) and a separate rear HVAC system 570 (e.g., configured to control the temperature associated with a rear compartment of the cabin 150 of the vehicle 100). In some embodiments, one of the front HVAC system 550 and the rear HVAC system 570 may control the temperature associated with an entirety of the cabin 150 of the vehicle 100.

In some embodiments, the nodes N1-N8 described in conjunction with the refrigerant system may correspond to one or more of the valves 494 described in conjunction with FIG. 4B, connections, junctions, T-joints, and/or the like. For instance, the nodes N1-N8 may include one or more passive or actively controlled connections between fluid lines. In some embodiments, the control of fluid flow along any fluid path, or line, may be controlled by one or more nodes associated with the path, or line.

A fluid line may run from the condenser 508 to node N1. From node N1, a fluid line may run to node N2. In some embodiments, a check valve 520 may be disposed between node N1 and node N2. The check valve 520 may prevent backflow, or fluid flow, in a direction running from node N2 to node N1 and only allow fluid flow in a direction running from node N1 to node N2. From node N2, a fluid line may run to a first inlet of the internal heat exchanger 544. In some embodiments, a reservoir 540 may be interconnected along the fluid line between node N2 and the internal heat exchanger 544.

From the internal heat exchanger 544 two outlets may exit to other components in the refrigerant system. In one embodiment, the first inlet may interconnect with the first outlet which is interconnectable to node N3. The second outlet of the internal heat exchanger 544 may be interconnectable to the accumulator 528, the compressor 532, and the multi-port control valve 536. The multi-port control valve 536 is shown as a four-way valve with ports labeled 1 to 4 lines. The direction of fluid flow through the multi-port control valve 536 may be controlled between any combination of ports 1 to 4. In some embodiments, flow may be restricted through any one or more ports 1 to 4 of the multi-port control valve 536. The multi-port control valve 536 may be controlled by the thermal control system processor(s) 490 based on information from the thermal control system sensors 433 and/or the user interface device(s) 488. Port 2 of the multi-port control valve 536 may run to the condenser 508. Port 3 of the multi-port control valve 536 may run to node N8 (e.g., disposed at the second inlet of the internal heat exchanger 544). Port 4 of the multi-port control valve 536 may run to the inner condenser 560 of the front HVAC system 550.

A fluid line runs from node N3 to the expansion valve 524 arranged adjacent to node N1. In addition, a fluid line runs from node N3 to node N4. At node N4 a fluid line runs to the expansion valve 524 associated with the evaporator 556 of the front HVAC system 550. A fluid line runs from the evaporator 556 of the front HVAC system 550 to node N7. In addition to the fluid line running to the expansion valve 524 of the front HVAC system 550, a fluid line runs from node N4 to node N5. At node N5 a first fluid line may run to the thermostatic expansion valve 552 of the evaporator 556 of the rear HVAC system 570. A fluid line runs from the evaporator 556 of the rear HVAC system 570 to node N6. A second fluid line runs from node N5 to the expansion valve 524 associated with the chiller 568. Upon exiting the chiller 568, a fluid line runs to node N6. A fluid line runs from node N6 to node N7 and another fluid line runs from node N7 to node N8. A fluid line runs from node N8 to the second inlet of the internal heat exchanger 544. The second inlet of the internal heat exchanger 544 is interconnected with the second outlet of the internal heat exchanger 544.

The thermal management system 500 is configured to transfer heat between or among a coolant circulating through the coolant system of thermal management system 500 and the refrigerant system of the thermal management system 500.

It should be appreciated that the thermal management systems described herein may be used in non-autonomous, semi-autonomous, and autonomous vehicles alike.

The first and second pumps 518A, 518B may be any pumps suitable for circulating coolant through the thermal management system 500. The pumps 518A, 518B may be selected based on the type of coolant being used (e.g., water, refrigerant, coolant, etc.); the total length of the coolant conduits (e.g., fluid lines, etc.) of the thermal management system 500; the flow rate(s) required to achieve sufficient thermal management of the components of the vehicle 100 and/or of the cabin 150 air temperature in the various operating modes of the thermal management system 500; the volume of coolant contained within the thermal management system 500; the total pressure drop across the components of the thermal management system 500; and the available power (whether from the battery 582 or elsewhere) for running the pumps 518A, 518B. The pumps 518A, 518B may each be independently capable of creating a pressure differential sufficient to circulate coolant through the thermal management system 500 in one or more configurations.

The high voltage heater 578 converts electrical energy into heat, which heat is transferred to water or other coolant being circulated through the thermal management system 500. The chiller 568 removes heat from the thermal management system coolant, and may be a vapor-compression chiller. The chiller 568 may comprise, for example, a reciprocating compressor, a scroll compressor, a screw-driven compressor, and/or a centrifugal compressor. The chiller 568 may utilize a refrigerant (separate from the coolant of the thermal management system 500) as a working fluid for extracting heat from the thermal management system coolant.

The battery 582 may be any battery or other power source that provides power to the vehicle 100. The battery 582 may operate most efficiently (and/or most safely) within certain temperature ranges, and therefore may require preheating before use (e.g., in cold temperatures) and/or cooling before and/or during use. The battery 582 may be the same as or similar to the power sources 208, 208A, 208B discussed above.

The radiator 504 may be any radiator known in the art that is suitable for transferring heat from coolant flowing therethrough to the surrounding atmosphere. The particular design and specifications of the radiator 504 may be selected, for example, based on the type of coolant being used in the thermal management system 500, and the needed volume flow rate of air to achieve the desired amount of cooling. In some embodiments, the radiator 504 may comprise an electrically operated fan or other device for generating airflow past the radiator 508 (e.g., the blower 512). The fan, or blower 512, may be used, for example, when the vehicle 100 is not moving, but the radiator is being used for extracting heat from coolant flowing therethrough.

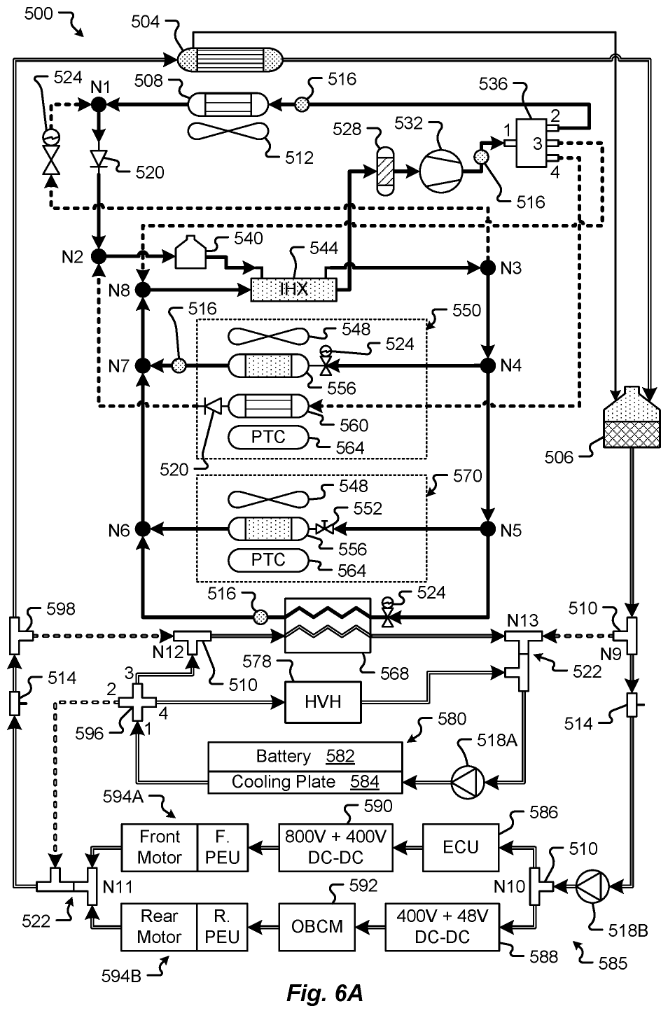

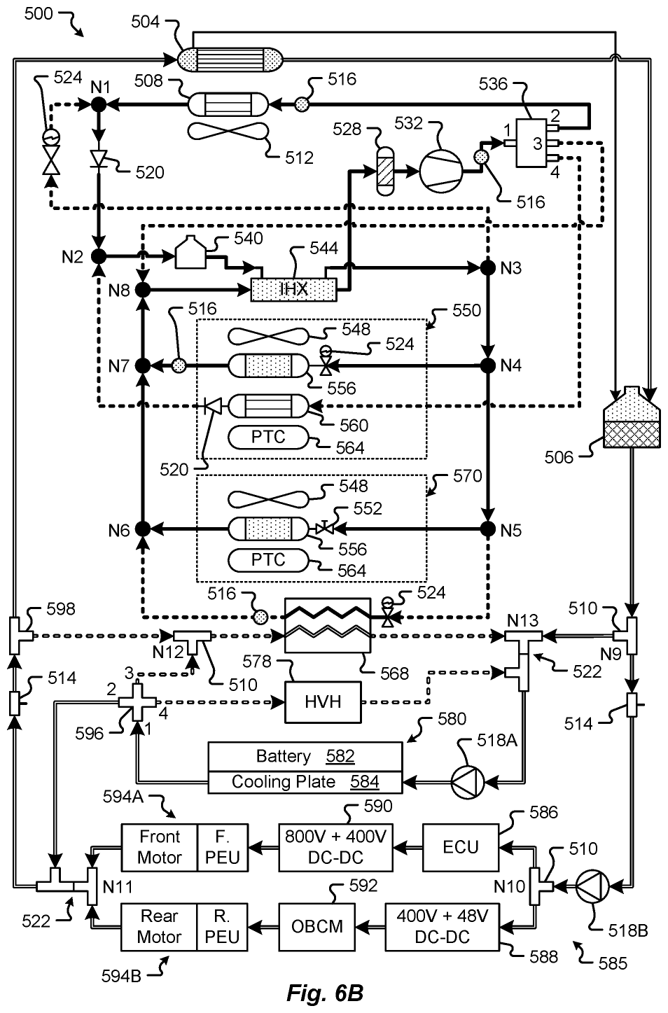

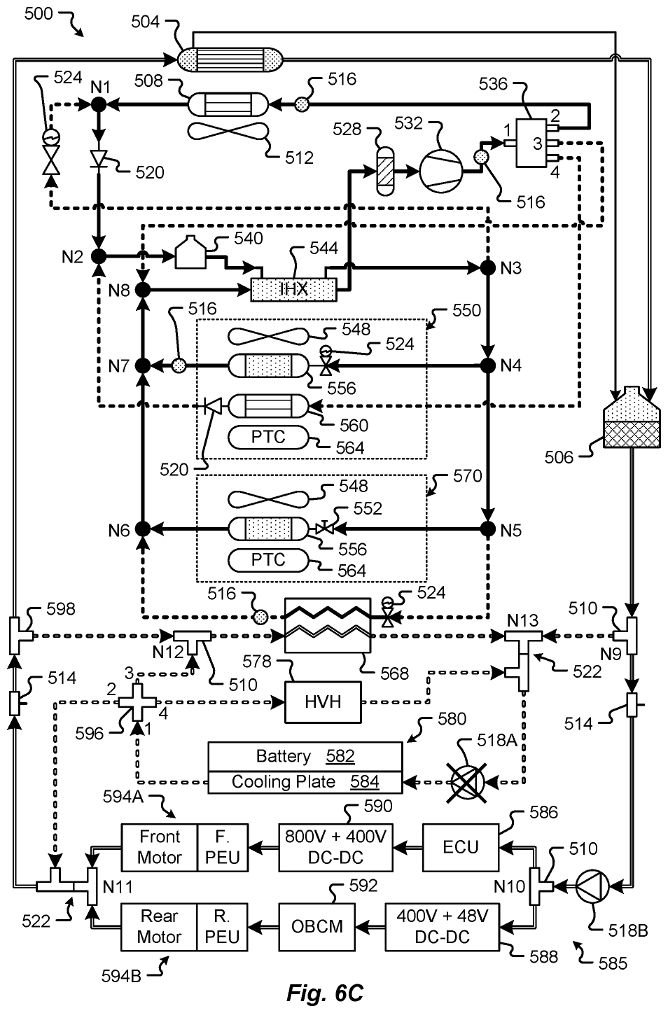

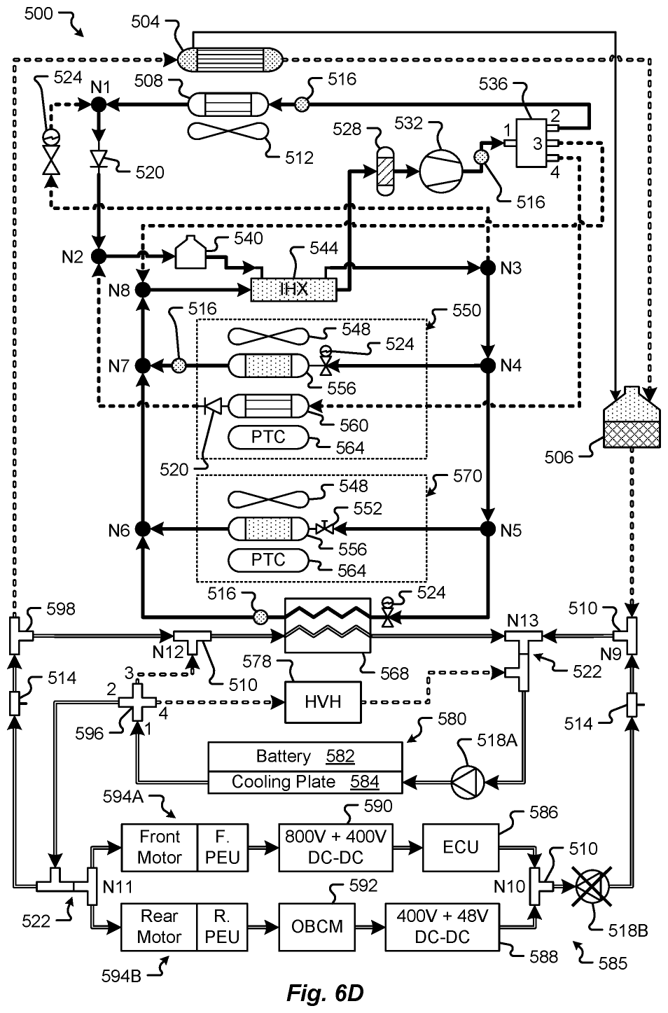

Various modes of operation of the thermal management system 500 will now be described with respect to FIGS. 6A-8C, in which active coolant flow paths are shown in solid lines between numbered elements, and inactive coolant flow paths are shown in dashed lines between numbered elements. Additionally, one or more of the pumps 518A, 518B may be shown with an overlapping “X” to indicate that the component is not functional in the particular mode being illustrated and described, even though coolant may still be routed therethrough.

With reference, then, to FIG. 6A, the thermal management system 500 may be placed in a first cooling mode that includes cooling the cabin 150 (e.g., via air conditioning), actively cooling the ESS 580, and passively cooling the EDS 585. In this mode, the refrigerant system, or AC loop, serves the front and rear HVAC systems 550, 570 as well as the chiller 568. Two expansion valves 524, one disposed at front HVAC system 550 and another disposed at the chiller 568, allow the load to be balanced and shut off to either the ESS 580 or cabin 150 to ensure cabin comfort and ESS 580 cooling can be achieved. In some embodiments, the primary control of the ESS 580 cooling load is made via the proportional valve 596. The rear HVAC system 570 includes a thermostatic expansion valve 552, that can be shut off if the front HVAC system 550 or ESS 580 requires additional capacity. In this mode, the coolant loop is separated into an ESS 580 loop that exchanges heat via the chiller 568, and an EDS 585 loop that exchanges heat via the low-temperature radiator (LTR) in the CRFM (e.g., the radiator 504, the condenser 508, and the blower 512, etc.).

In FIG. 6A, the multi-port control valve 536 directs fluid flow from port 1 to port 2 in a direction toward the condenser 508. The proportional valve 596 directs coolant flow received at port 1 from the exit side of the ESS 580 to port 2 in a direction toward the multi-port valve 522 at node N11. As shown in FIG. 6A, the coolant from the radiator 504 is directed to the valve 510 at node N9 and then diverted to the ESS 580 and the EDS 585. The flow of coolant through the EDS 585 is shown as being routed from the inlet side of the EDS 585 (e.g., at node N10) in a direction toward the outlet side of the EDS 585 (e.g., at node N11).

Referring to FIG. 6B, a diagram of the thermal management system 500 is shown in a second cooling mode in accordance with embodiments of the present disclosure. The second cooling mode includes cooling the cabin 150, passively cooling the ESS 580, and passively cooling the EDS 585. The refrigerant system, or AC loop, serves the front and rear HVAC systems 550, 570. In this second cooling mode, the expansion valve 524 at the front HVAC system 550 controls cabin comfort, the expansion valve 524 at the chiller 568 is closed, and the rear HVAC system 570 includes the thermostatic expansion valve 552 (e.g., a solenoid operated and controlled valve, etc.) that it can be shut off, if required. The coolant system bypasses the chiller 568 and the high-voltage heater 578 in this mode, placing the ESS 580 in parallel with each branch of the EDS 585. The coolant loop in this mode exchanges heat via the LTR in the CRFM.

In the mode illustrated in FIG. 6B, the multi-port control valve 536 directs fluid flow from port 1 to port 2 in a direction toward the condenser 508. The proportional valve 596 directs coolant flow received at port 1 from the exit side of the ESS 580 to port 2 in a direction toward the multi-port valve 522 at node N11. As shown in FIG. 6A, the coolant from the radiator 504 is directed to the valve 510 at node N9 and then diverted to the ESS 580 and the EDS 585. The flow of coolant through the EDS 585 is shown as being routed from the inlet side of the EDS 585 (e.g., at node N10) in a direction toward the outlet side of the EDS 585 (e.g., at node N11).

FIG. 6C is a diagram of the thermal management system 500, in a first pump 518A (e.g., ESS 580 loop pump) failure mode in accordance with embodiments of the present disclosure. In the event that the first pump 518A fails, this mode ensures that ESS 580, EDS 585, and other electronic equipment (e.g., including at least one ADAS component, etc.) temperatures can be controlled until the vehicle 100 can come to a safe stop (e.g., fail operational). For instance, in this failure mode, the ESS 580 is completely bypassed. Due to the large thermal mass of the ESS 580, a critical operating point will not be reached in 2 minutes (fail operational requirement). The refrigerant system and various AC loops maintain the function of serving front and rear HVAC systems 550, 570. The expansion valve 524 at front HVAC system 550 controls cabin comfort and the expansion valve 524 at the chiller 568 is closed. The rear HVAC system 570 has a solenoid-operated thermostatic expansion valve 552 that it can be shut off, if required.

In FIG. 6C, the multi-port control valve 536 directs fluid flow from port 1 to port 2 in a direction toward the condenser 508. The proportional valve 596, in the first pump 518A failure mode, directs no coolant flow. The coolant, in this mode, is routed from the radiator 504 to the valve 510 at node N9 and then to the EDS 585 (bypassing the ESS 580). The flow of coolant through the EDS 585 is shown as being routed from the inlet side of the EDS 585 (e.g., at node N10) in a direction toward the outlet side of the EDS 585 (e.g., at node N11).

FIG. 6D is a diagram of the thermal management system 500 in a second pump 518B failure mode in accordance with embodiments of the present disclosure. In the event that the second pump 518B fails, this failure mode ensures that the ESS 580, EDS 585, and other electronic equipment (e.g., including at least one ADAS component, etc.) temperatures can be controlled until the vehicle 100 can come to a safe stop (e.g., fail operational). In this mode, the refrigerant system, or AC loop, maintains the function of serving front and rear HVAC systems 550, 570 as well as the chiller 568, but depending on the coolant temperature, the chiller 568 may need to be prioritized to maintain the EDS 585 and electronics coolant loop or the ESS 580 loop target temperatures. The expansion valves 524 at front HVAC system 550 and the chiller 568 facilitates this control. The rear HVAC system includes a solenoid-operated thermostatic expansion valve 552 that can be shut off, if required.

As illustrated in FIG. 6D, the coolant loop flow is reversed through the EDS 585. Coolant flow through the chiller 568 is in parallel to the EDS 585 coolant loop such that heat is exchanged via the chiller 568 to the refrigerant system, or circuit. The flow is combined through the first pump 518A (e.g., the ESS 580 pump) and then the ESS 580. In this mode, the high-voltage heater 578 is bypassed. The multi-port control valve 536 directs fluid flow from port 1 to port 2 in a direction toward the condenser 508. The proportional valve 596 directs coolant flow received at port 1 from the exit side of the ESS 580 to port 2 in a direction toward the multi-port valve 522 at node N11. From this point, a portion of the coolant is directed to node N11 and the flow of coolant through the EDS 585 is shown as being routed from the outlet side of the EDS 585 (e.g., at node N11) in a direction toward the inlet side of the EDS 585 (e.g., at node N10), referred to herein as a reverse flow. The coolant from the radiator 504 is directed to the valve 510 at node N9 and then directed to the ESS 580 via the multi-port valve 522 at node N13. Coolant that has been directed in the reverse flow through the EDS 585 is received at the valve 510 at node N9 and is then directed to the ESS 580 via the multi-port valve 522 at node N13.

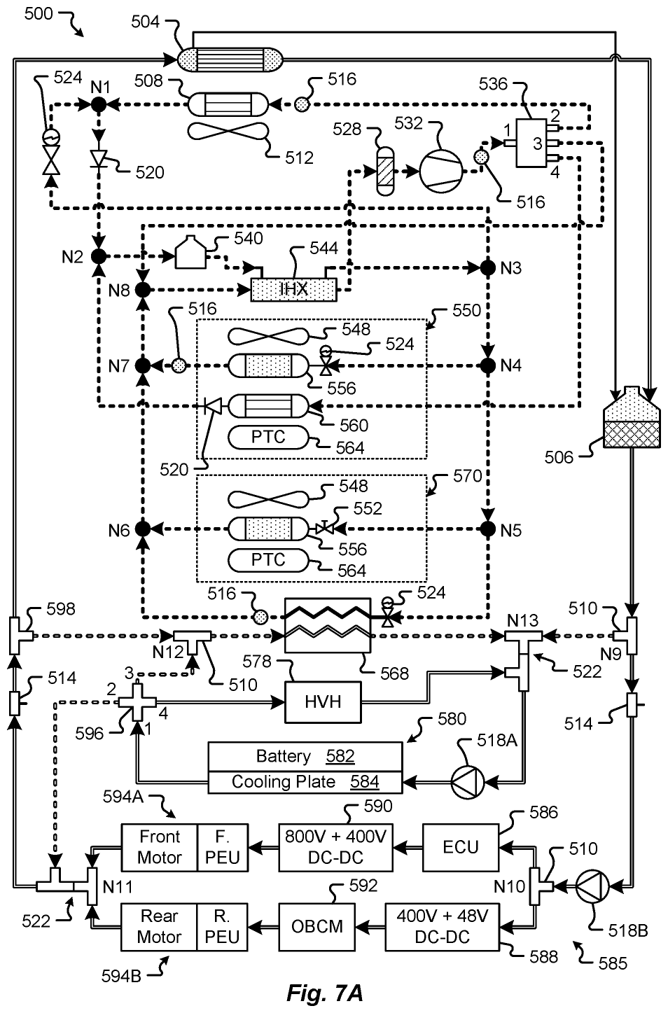

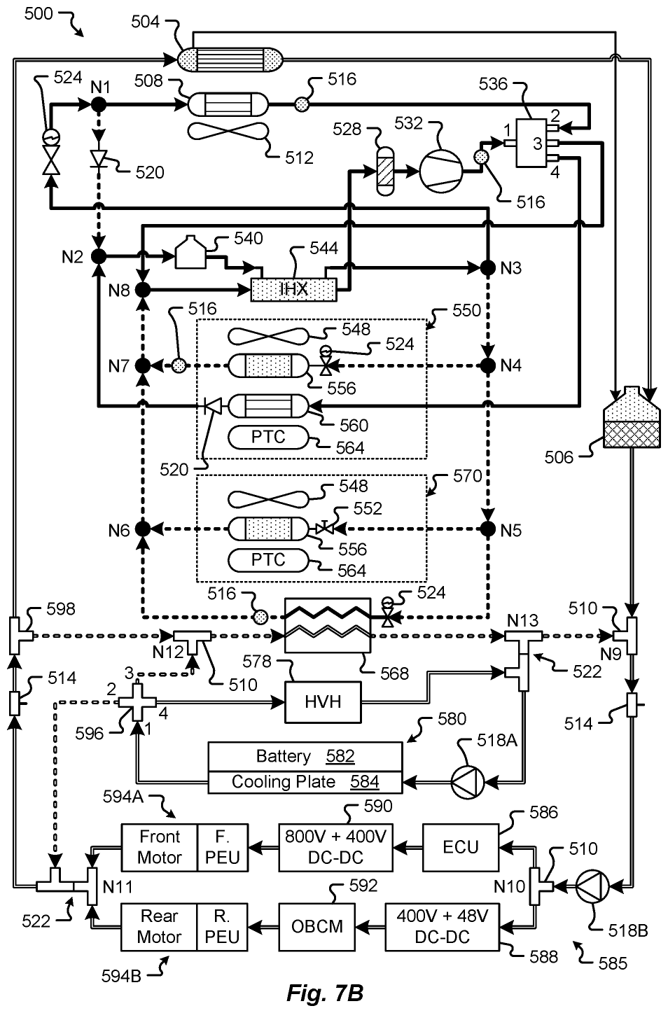

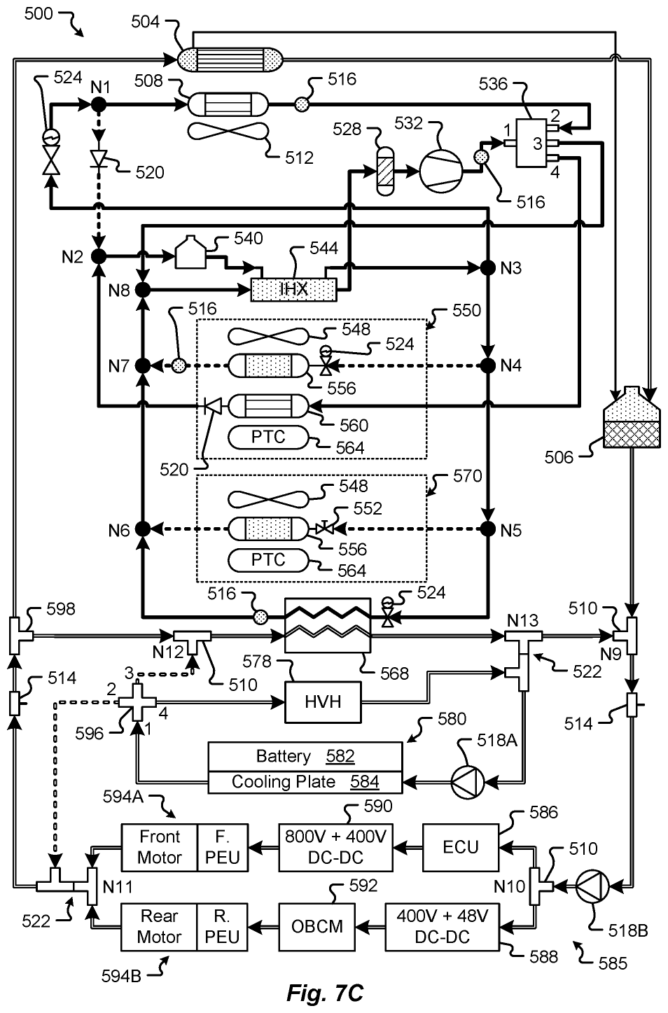

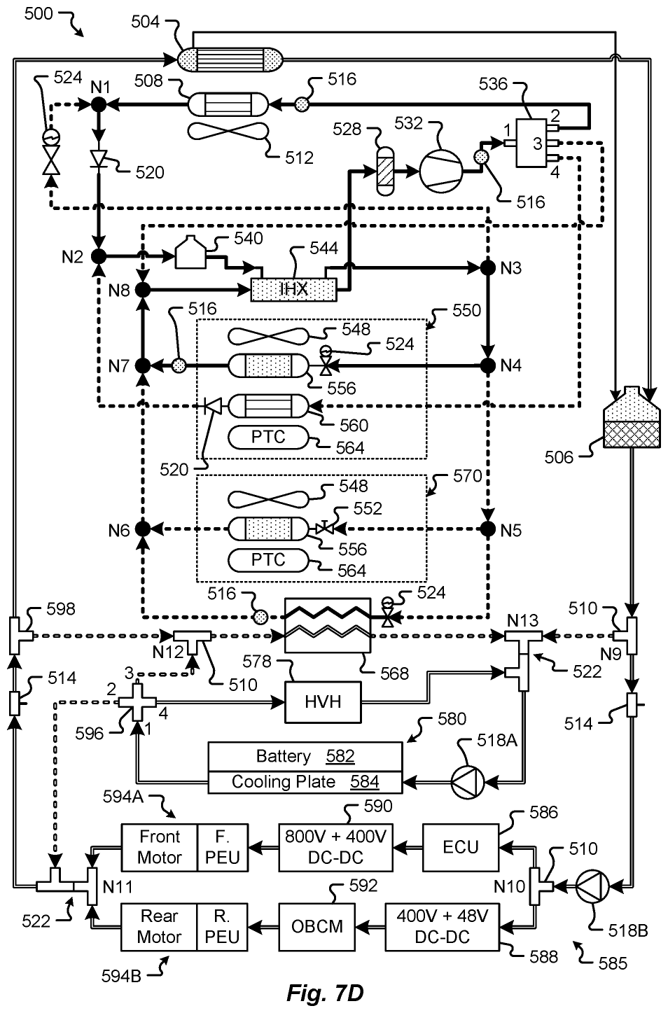

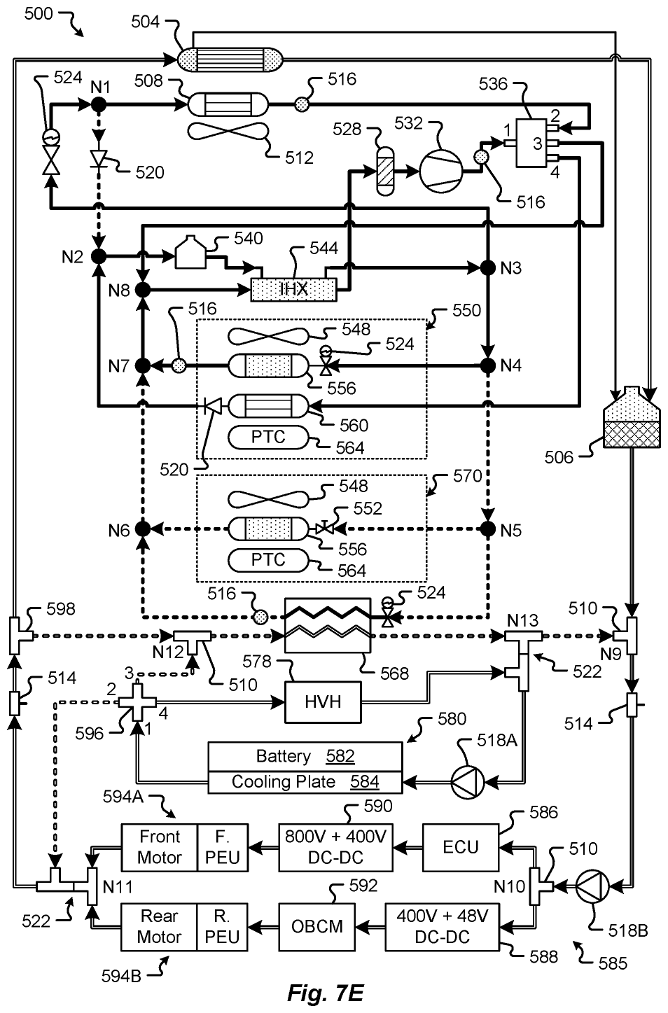

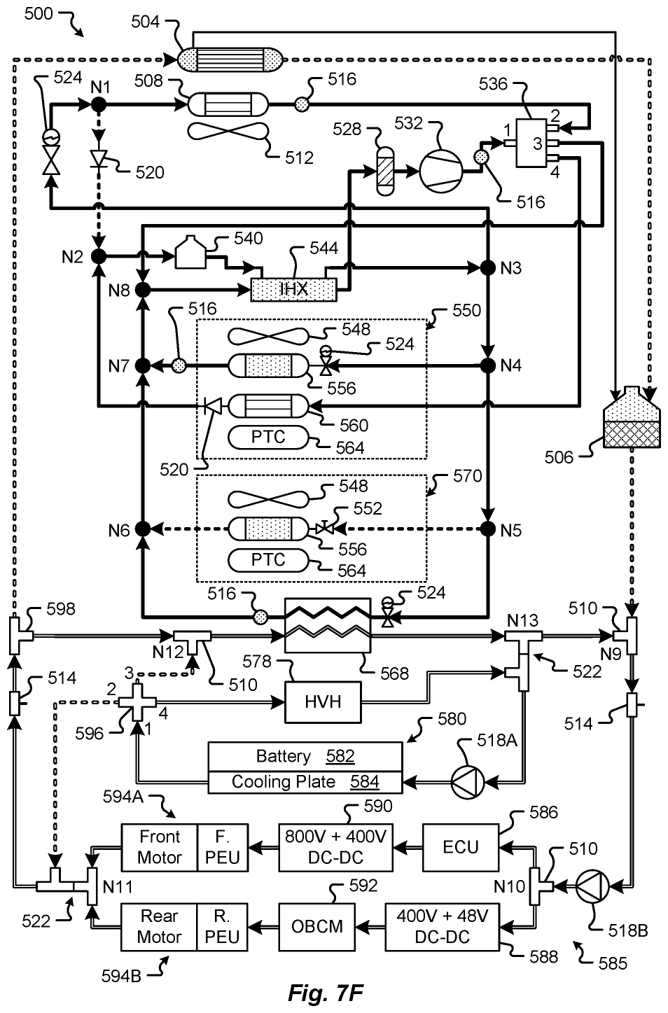

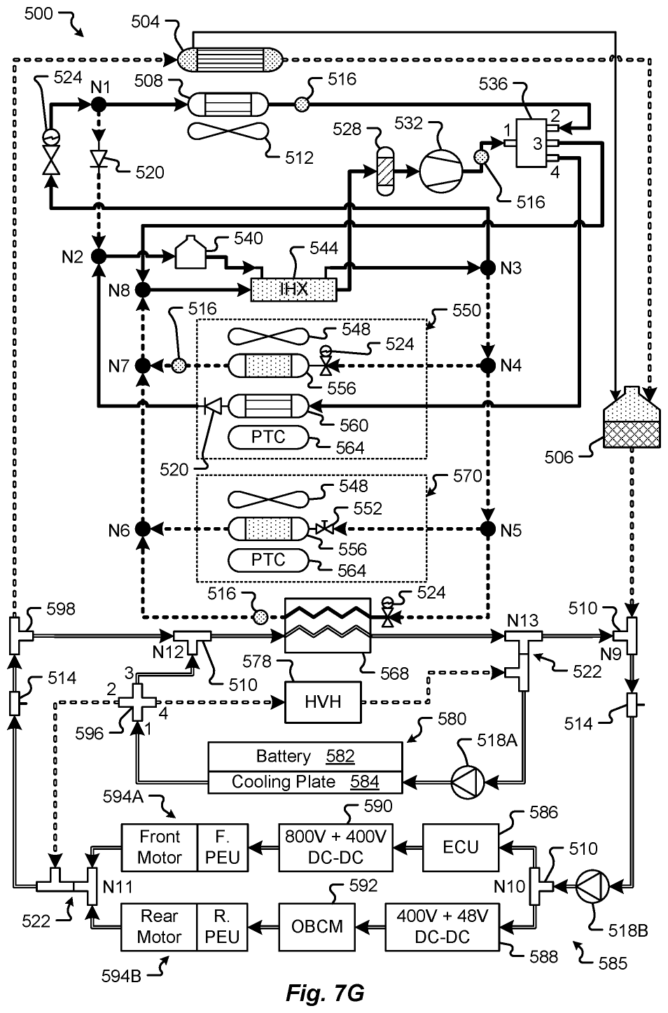

FIG. 7A is a diagram of the thermal management system 500 in a first heating mode in accordance with embodiments of the present disclosure. The first heating mode may correspond to a maximum heating mode for the cabin 150 and the ESS 580. As illustrated in FIG. 7A, the positive temperature coefficient heaters 564 in the front and rear HVAC systems 550, 570 are used to heat the cabin 150 of the vehicle 100. When the ambient temperature (e.g., in a surrounding environment of the vehicle 100, etc.) is below −20° C. then a heat pump mode is not available and the positive temperature coefficient heaters 564 are the primary heating source. The high-voltage heater 578 in the ESS 580 coolant loop is used to heat the battery 582. The coolant in the EDS 585 loop is circulated via the radiator 504 (e.g., with no airflow) to maintain uniform temperature distribution in the components of the EDS 585.

The multi-port control valve 536, in FIG. 7A, is not actively directing fluid flow. The proportional valve 596 directs coolant flow received from the ESS 580 at port 1 to port 4 and then to the high-voltage heater 578. In this mode, the ESS 580 is isolated from the EDS 585 and the refrigerant system. The flow of coolant through the EDS 585 is shown as being routed from the inlet side of the EDS 585 (e.g., at node N10) in a direction toward the outlet side of the EDS 585 (e.g., at node N11).

FIG. 7B is a diagram of the thermal management system 500 in a second heating mode in accordance with embodiments of the present disclosure. The second heating mode may correspond to a heat pump and positive temperature coefficient heater 564 maximum heating mode, without heat harvest (e.g., cold start). As illustrated in FIG. 7B, the heat pump functionality is used at the lowest effective temperature to minimize electric power consumption. In this mode, the positive temperature coefficient heater 564 heating at the front HVAC system 550 will be primary heat source at lower temperatures. The rear HVAC system 570 heating is realized entirely over the positive temperature coefficient heater 564 associated therewith. In some embodiments, the front HVAC system 550 uses the positive temperature coefficient heater 564 associated therewith as necessary to supplement the inner condenser 560.

As illustrated in FIG. 7B, the multi-port control valve 536 directs fluid flow from port 1 to port 4 in a direction toward the inner condenser 560. Further, the multi-port control valve 536 directs refrigerant received from the condenser 508 at port 2 to port 3 in a direction toward node N8 and the internal heat exchanger 544. The proportional valve 596 directs coolant flow received from the ESS 580 at port 1 to port 4 and then to the high-voltage heater 578. In this mode, the ESS 580 is isolated from the EDS 585 and the refrigerant system. As shown in FIG. 7B, the coolant from the radiator 504 is directed to the valve 510 at node N9 and then directed to the EDS 585. The flow of coolant through the EDS 585 in this mode is shown as being routed from the inlet side of the EDS 585 (e.g., at node N10) in a direction toward the outlet side of the EDS 585 (e.g., at node N11).

FIG. 7C is a diagram of the thermal management system 500 in a third heating mode in accordance with embodiments of the present disclosure. The third heating mode may correspond to a heat pump with heat harvest mode. As illustrated in FIG. 7C, the heat pump functionality is used at the lowest effective temperature to minimize electric power consumption, for example, by using waste heat from the EDS 585 components, the minimum ambient operating temperature of the heat pump can be lowered, reducing the positive temperature coefficient heater 564 use. The heat is transferred to the refrigerant from the EDS 585 coolant loop via the chiller 568. The ESS 580 loop is isolated and the ESS 585 is heated with the high-voltage heater 578. The LTR in this mode is completely bypassed. Moreover, the rear HVAC system 570 heating is realized entirely over the positive temperature coefficient heater 564 associated therewith, and the front HVAC system 550 uses the positive temperature coefficient heater 564 associated therewith as necessary to supplement the inner condenser 560.

In FIG. 7C, the multi-port control valve 536 directs fluid flow from port 1 to port 4 in a direction toward the inner condenser 560. Further, the multi-port control valve 536 directs refrigerant received from the condenser 508 at port 2 to port 3 in a direction toward node N8 and the internal heat exchanger 544. The proportional valve 596 directs coolant flow received from the ESS 580 at port 1 to port 4 and then to the high-voltage heater 578. In this mode, the ESS 580 is interconnected with at least the EDS 585 coolant loop and the refrigerant system. As shown in FIG. 7B, the coolant from the radiator 504 is directed to the valve 510 at node N9 and then directed to the EDS 585. The flow of coolant through the EDS 585 in this mode is shown as being routed from the inlet side of the EDS 585 (e.g., at node N10) in a direction toward the outlet side of the EDS 585 (e.g., at node N11).

Referring to FIG. 7D, a diagram of the thermal management system 500 in a first dehumidification mode is shown in accordance with embodiments of the present disclosure. The first dehumidification mode may correspond to a mode in which dehumidification is made without the heat pump (e.g., AC mode with positive temperature coefficient heater 564). In this mode, the dehumidification at the front HVAC system 550 is achieved using cooling at the evaporator 556 of the front HVAC system 550 and reheating via the positive temperature coefficient heater 564 of the front HVAC system 550.

In this first dehumidification mode, the multi-port control valve 536 directs fluid flow from port 1 to port 2 in a direction toward the condenser 508. The proportional valve 596 directs coolant flow received from the ESS 580 at port 1 to port 4 and then to the high-voltage heater 578. In this mode, the ESS 580 is isolated from the EDS 585 and the refrigerant system. As shown in FIG. 7B, the coolant from the radiator 504 is directed to the valve 510 at node N9 and then directed to the EDS 585. The flow of coolant through the EDS 585 in this mode is shown as being routed from the inlet side of the EDS 585 (e.g., at node N10) in a direction toward the outlet side of the EDS 585 (e.g., at node N11). The chiller 568 is not actively used in this first dehumidification mode.

FIG. 7E is a diagram of the thermal management system 500 in a second dehumidification mode in accordance with embodiments of the present disclosure. The second dehumidification mode may correspond to a mode in which dehumidification is made with heat pump and without heat harvest. Dehumidification is achieved at the front HVAC system 550 using heat pump. In this mode, the condenser 508 is used as an evaporating device. Air at evaporator 556 associated with the front HVAC system 550 is cooled (e.g., dehumidified) and reheated at the inner condenser 560.

The multi-port control valve 536 in this mode directs fluid flow from port 1 to port 4 in a direction toward the inner condenser 560. Further, the multi-port control valve 536 directs refrigerant received from the condenser 508 at port 2 to port 3 in a direction toward node N8 and the internal heat exchanger 544. The proportional valve 596 directs coolant flow received from the ESS 580 at port 1 to port 4 and then to the high-voltage heater 578. In this mode, the ESS 580 is isolated from the EDS 585 and the refrigerant system. Coolant from the radiator 504 is directed to the valve 510 at node N9 and then directed to the EDS 585. The flow of coolant through the EDS 585 in this mode is shown as being routed from the inlet side of the EDS 585 (e.g., at node N10) in a direction toward the outlet side of the EDS 585 (e.g., at node N11).

FIG. 7F is a diagram of the thermal management system 500 in a third dehumidification mode in accordance with embodiments of the present disclosure. The third dehumidification mode may correspond to a mode in which dehumidification is made with heat pump and heat harvest. Dehumidification is achieved at the front HVAC system 550 using heat pump. The condenser 508 is used as an evaporating device. Air at the evaporator 556 of the front HVAC system 550 is cooled (e.g., dehumidified) and reheated at the inner condenser 560. The chiller 568 is used for harvesting waste heat from the EDS 585.

In the mode illustrated in FIG. 7F, the multi-port control valve 536 directs fluid flow from port 1 to port 4 in a direction toward the inner condenser 560. Further, the multi-port control valve 536 directs refrigerant received from the condenser 508 at port 2 to port 3 in a direction toward node N8 and the internal heat exchanger 544. The proportional valve 596 directs coolant flow received from the ESS 580 at port 1 to port 4 and then to the high-voltage heater 578. The valve 510 at node N9 receives coolant from the multi-port valve 522 at node N13 and directs the coolant to the EDS 585. The flow of coolant through the EDS 585 in this mode is shown as being routed from the inlet side of the EDS 585 (e.g., at node N10) in a direction toward the outlet side of the EDS 585 (e.g., at node N11).

FIG. 7G is a diagram of the thermal management system 500 in a heat pump mode in accordance with embodiments of the present disclosure. The heat pump mode may correspond to a heat pump mode in which heat from the EDS 585 is used to heat the ESS 580. In this mode, the proportional valve 596 and the loop control valve 598 in the coolant loop are configured to deliver the flow from EDS 585 (e.g., the front and rear motor electronics 594A, 594B loop) to the battery 582 via the chiller 568. The multi-port control valve 536 directs fluid flow from port 1 to port 4 in a direction toward the inner condenser 560. Further, the multi-port control valve 536 directs refrigerant received from the condenser 508 at port 2 to port 3 in a direction toward node N8 and the internal heat exchanger 544.

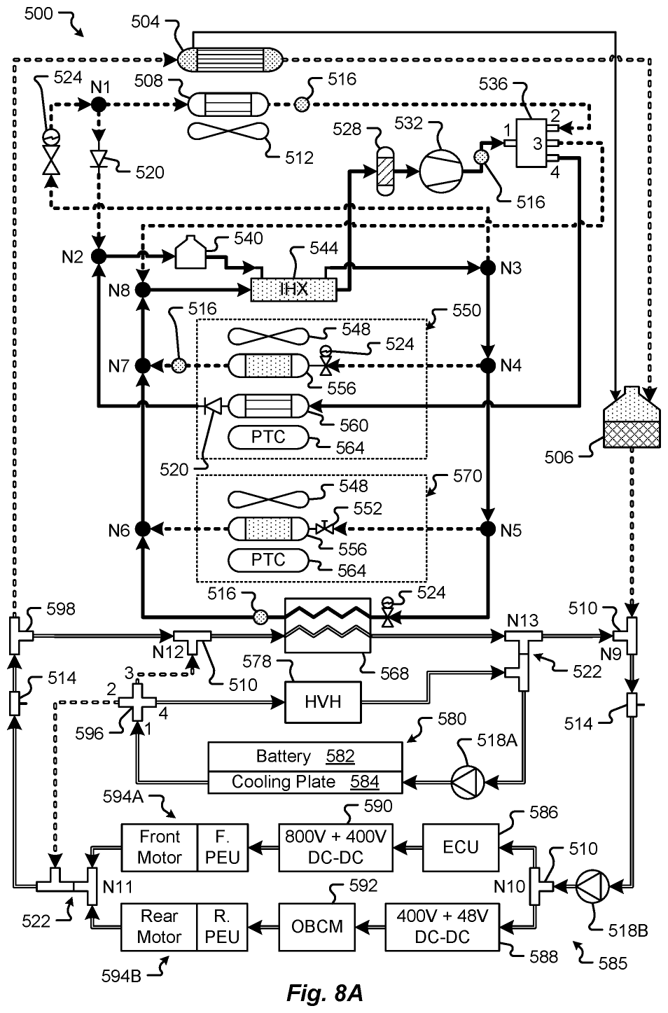

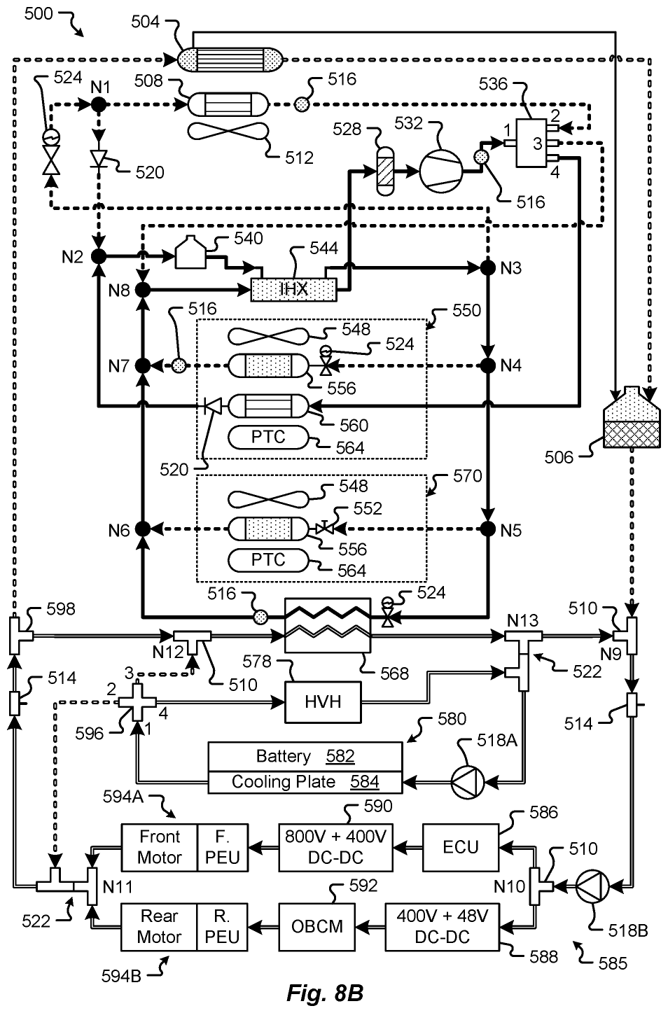

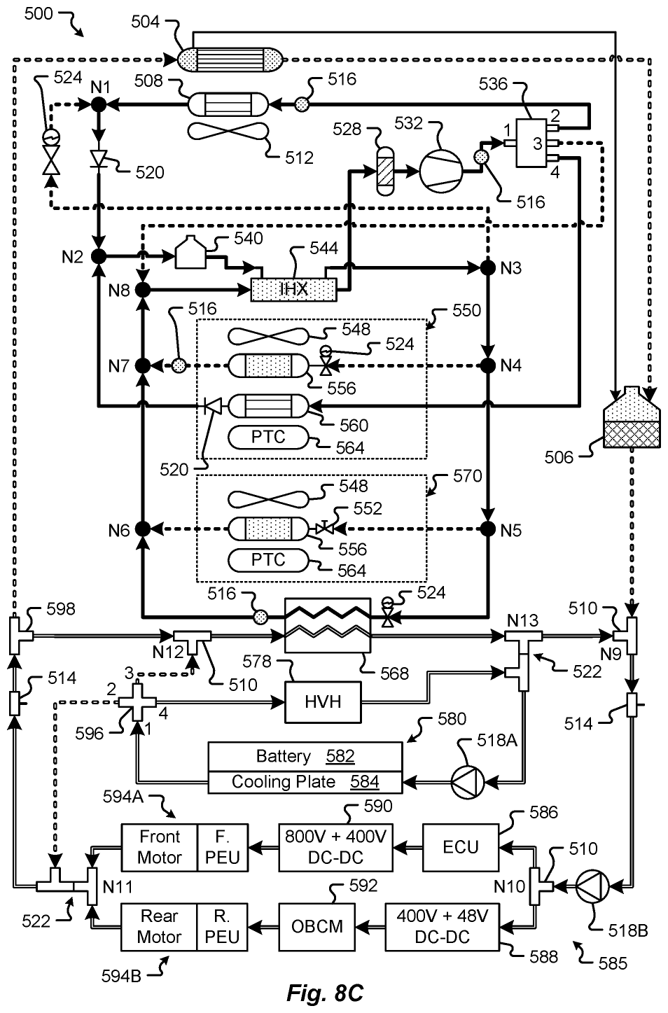

Referring now to FIG. 8A, a diagram of the thermal management system 500 in a first deicing mode is shown in accordance with embodiments of the present disclosure. This first deicing mode may correspond to an outside condenser (e.g., condenser 508) deicing mode with heat harvesting at the chiller 568. In this heat pump mode, the condenser 508 deicing is achieved via switching off the refrigerant flow to the condenser 508 and balancing the inner condenser 560 heat transfer with waste heat received at chiller 568. The multi-port control valve 536 directs fluid flow from port 1 to port 4 in a direction toward the inner condenser 560. The proportional valve 596 directs coolant flow received from the ESS 580 at port 1 to port 4 and then to the high-voltage heater 578. The valve 510 at node N9 receives coolant from the multi-port valve 522 at node N13 and directs the coolant to the EDS 585. The flow of coolant through the EDS 585 in this mode is shown as being routed from the inlet side of the EDS 585 (e.g., at node N10) in a direction toward the outlet side of the EDS 585 (e.g., at node N11).

FIG. 8B is a diagram of the thermal management system 500 in a second deicing mode in accordance with embodiments of the present disclosure. This second deicing mode may correspond to an outside condenser (e.g., condenser 508) deicing in dehumidification mode. In this deicing and dehumidification mode with heat pump, the condenser 508 deicing is achieved via switching off the refrigerant flow to condenser 508 and balancing the inner condenser 560 heat transfer with cooling (e.g., dehumidification) at the evaporator 556 of the front HVAC system 550 plus waste heat at the chiller 568. The multi-port control valve 536 directs fluid flow from port 1 to port 4 in a direction toward the inner condenser 560. The proportional valve 596 directs coolant flow received from the ESS 580 at port 1 to port 4 and then to the high-voltage heater 578. The valve 510 at node N9 receives coolant from the multi-port valve 522 at node N13 and directs the coolant to the EDS 585. The flow of coolant through the EDS 585 in this mode is shown as being routed from the inlet side of the EDS 585 (e.g., at node N10) in a direction toward the outlet side of the EDS 585 (e.g., at node N11).

FIG. 8C is a diagram of the thermal management system 500 in a third deicing mode in accordance with embodiments of the present disclosure. This third deicing mode may correspond to an outside condenser (e.g., condenser 508) active deicing with heat harvesting at the chiller 568. In this mode, the condenser 508 deicing is achieved via switching on the AC mode, where hot refrigerant from the compressor 532 enters the condenser 508 (e.g., via the multi-port control valve 536 directing fluid flow from port 1 to port 2 in a direction toward the condenser 508) and hence deicing the condenser 508. The evaporation load in the system 500 comes from waste heat at the chiller 568. In addition to directing fluid flow from port 1 to port 2, the multi-port control valve 536 may direct at least a portion of the fluid from port 1 to port 4 in a direction toward the inner condenser 560. The proportional valve 596 directs coolant flow received from the ESS 580 at port 1 to port 4 and then to the high-voltage heater 578. The valve 510 at node N9 receives coolant from the multi-port valve 522 at node N13 and directs the coolant to the EDS 585. The flow of coolant through the EDS 585 in this mode is shown as being routed from the inlet side of the EDS 585 (e.g., at node N10) in a direction toward the outlet side of the EDS 585 (e.g., at node N11).

As may be appreciated given the foregoing description and accompanying drawings, many of the operational modes of thermal management systems of the present disclosure utilize only one pump. The inclusion of two pumps in such systems, then, allows for enhanced operation when both pumps are utilized, but also enables the thermal management systems of the present disclosure to continue to operate in numerous modes even if one of the two pumps fails. At the same time, thermal management systems of the present disclosure may in some embodiments have no more than two pumps, because the system can be safely operated, with sufficient redundancy, with only two pumps.

Additionally, the present disclosure encompasses thermal management systems that comprise additional elements beyond those described herein, including both additional elements to be heated and/or cooled, as well as additional elements for heating and/or cooling the coolant flowing through the system.

Any of the foregoing thermal management system embodiments may utilize water as the coolant thereof. In some embodiments, other coolants may be used, including water-chemical mixtures (e.g., water mixed with ethylene glycol), glycol-based fluids without water,

A number of variations and modifications of the disclosure can be used. It would be possible to provide for some features of the disclosure without providing others.

In some embodiments, one or more aspects of the present disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing one or more aspects of the present disclosure illustrated herein can be used to implement the one or more aspects of this disclosure.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments of the present disclosure include a thermal management system comprising: a chiller; a coolant system, comprising: a first coolant loop comprising a radiator having a first port and a second port, the first coolant loop configured to route coolant from the second port to the first port via a first fluid path; a second coolant loop separate from the first coolant loop and comprising a first pump, an energy storage system (ESS), and a high-voltage heater; and a third coolant loop separate from the first and second coolant loops, the third coolant loop comprising a second pump and an electrical drive system (EDS); wherein the first coolant loop is interconnectable with at least one of the second coolant loop and the third coolant loop via a first valve, the second coolant loop is interconnectable with the third coolant loop via a first four-way valve, the first coolant loop is interconnectable with the chiller via a chiller fluid path, and at least one of the second coolant loop and the third coolant loop is interconnectable with the chiller; and a refrigerant system separate from the coolant system, the refrigerant system comprising: a condenser; and an internal heat exchanger interconnectable with the condenser and the chiller.

Aspects of the above thermal management system include: wherein the refrigerant system further comprises: a first heating, ventilation, and air conditioning (HVAC) system interconnectable with the internal heat exchanger; wherein the refrigerant system further comprises: a second HVAC system interconnectable with the internal heat exchanger; wherein the refrigerant system further comprises: a second four-way valve disposed between the internal heat exchanger and the condenser, comprising a first port, a second port, a third port, and a fourth port, and wherein one outlet of the internal heat exchanger is interconnectable with the condenser via the first and second ports of the second four-way valve; wherein the third port of the second four-way valve is interconnectable with one inlet of the internal heat exchanger, and wherein the fourth port of the second four-way valve is interconnectable with an inner condenser of the first HVAC system; wherein the first valve is configured to route the coolant from the first coolant loop into the second coolant and the third coolant loop; wherein coolant exiting the ESS enters the first four-way valve and is directed to an exit side of the third coolant loop, and wherein coolant exiting the EDS and the coolant exiting the ESS is routed to the radiator in the first coolant loop; wherein the first valve is configured to route the coolant from the first coolant loop into the third coolant loop without routing the coolant from the first coolant loop into the second coolant loop, wherein coolant exiting the EDS is routed to the radiator in the first coolant loop, and wherein any coolant or refrigerant is prevented from flowing through the chiller; wherein the first coolant loop is separated from the second and third coolant loops, wherein coolant is pumped across the ESS and the coolant exiting the ESS is routed to an exit side of the EDS and split between a first route through the chiller and toward an inlet side of the ESS and a second route through the EDS flowing in a direction from the exit side of the EDS to an inlet side of the EDS across the second pump and toward the first valve, and wherein the first valve is configured to route a portion of the coolant from the EDS back into the second coolant loop at the inlet side of the ESS; and wherein the first HVAC system further comprises a first fan, a first evaporator, and a first positive temperature coefficient heater, wherein an other outlet of the internal heat exchanger is interconnectable with the first evaporator via a refrigerant line, wherein the second HVAC system comprises a second fan, a second evaporator, and a second positive temperature coefficient heater, wherein the other outlet of the internal heat exchanger is interconnectable with the second evaporator via a refrigerant line, and wherein the refrigerant line is interconnectable with the chiller.

Embodiments of the present disclosure also include an electric vehicle comprising: an energy storage system (ESS) comprising a battery; an electrical drivetrain system (EDS) comprising at least one motor, the EDS powered by the ESS; and a thermal management system, the thermal management system comprising: a chiller; a coolant system, comprising: a first coolant loop comprising a radiator having a first port and a second port, the first coolant loop configured to route coolant from the second port to the first port via a first fluid path; a second coolant loop separate from the first coolant loop and comprising a first pump, the ESS, and a high-voltage heater; and a third coolant loop separate from the first and second coolant loops, the third coolant loop comprising a second pump and the EDS; wherein the first coolant loop is interconnectable with at least one of the second coolant loop and the third coolant loop via a first valve, the second coolant loop is interconnectable with the third coolant loop via a first four-way valve, the first coolant loop is interconnectable with the chiller via a chiller fluid path, and at least one of the second coolant loop and the third coolant loop is interconnectable with the chiller; and a refrigerant system separate from the coolant system, the refrigerant system comprising: a condenser; and an internal heat exchanger interconnectable with the condenser and the chiller.

Aspects of the above electric vehicle include any of the aspects of the thermal management system described above, as well as: wherein the refrigerant system further comprises: a first heating, ventilation, and air conditioning (HVAC) system interconnectable with the internal heat exchanger; wherein the refrigerant system further comprises: a second HVAC system interconnectable with the internal heat exchanger; wherein the refrigerant system further comprises: a second four-way valve disposed between the internal heat exchanger and the condenser, comprising a first port, a second port, a third port, and a fourth port, and wherein a first outlet of the internal heat exchanger is interconnectable with the condenser via the first and second ports of the second four-way valve; wherein the third port of the second four-way valve is interconnectable with a first inlet of the internal heat exchanger, and wherein the fourth port of the second four-way valve is interconnectable with an inner condenser of the first HVAC system; wherein the first valve is configured to route the coolant from the first coolant loop into the second coolant and the third coolant loop; wherein coolant exiting the ESS enters the first four-way valve and is directed to an exit side of the third coolant loop, and wherein coolant exiting the EDS and the coolant exiting the ESS is routed to the radiator in the first coolant loop; wherein the first valve is configured to route the coolant from the first coolant loop into the third coolant loop without routing the coolant from the first coolant loop into the second coolant loop, wherein coolant exiting the EDS is routed to the radiator in the first coolant loop, and wherein any coolant or refrigerant is prevented from flowing through the chiller; and wherein the first coolant loop is separated from the second and third coolant loops, wherein coolant is pumped across the ESS and the coolant exiting the ESS is routed to an exit side of the EDS and split between a first route through the chiller and toward an inlet side of the ESS and a second route through the EDS flowing in a direction from the exit side of the EDS to an inlet side of the EDS across the second pump and toward the first valve, and wherein the first valve is configured to route a portion of the coolant from the EDS back into the second coolant loop at the inlet side of the ESS.

Embodiments of the present disclosure further include a system for managing thermal energy in an electric vehicle, comprising: a chiller; a coolant system configured to extract heat from at least one of an energy storage system (ESS) and an electrical drive system (EDS), the coolant system comprising: a first coolant loop comprising a radiator having a first port and a second port, the first coolant loop configured to route coolant from the second port to the first port via a first fluid path; a second coolant loop separate from the first coolant loop and comprising a first pump, the ESS, and a high-voltage heater; and a third coolant loop separate from the first and second coolant loops, the third coolant loop comprising a second pump and the EDS; wherein the first coolant loop is interconnectable with at least one of the second coolant loop and the third coolant loop via a first valve, the second coolant loop is interconnectable with the third coolant loop via a first four-way valve, the first coolant loop is interconnectable with the chiller via a chiller fluid path, and at least one of the second coolant loop and the third coolant loop is interconnectable with the chiller; and a refrigerant system separate from the coolant system and configured to control a temperature of a cabin of the vehicle, the refrigerant system comprising: a condenser; and an internal heat exchanger interconnectable with the condenser and the chiller.

Aspects of the above system for managing thermal energy in the vehicle include any of the aspects of the thermal management system and of the electric vehicle listed above.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with onboard rechargeable energy storage, including electric vehicles and hybrid electric vehicles.

Examples of processors as referenced herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ARIVI926EJS™ processors. A processor as disclosed herein may perform computational functions using any known or future-developed standard, instruction set, libraries, and/or architecture.

What is claimed is:

1. A thermal management system, comprising:
a chiller;
a coolant system, comprising:
a first coolant loop comprising a radiator having a first port and a second port, the first coolant loop configured to route coolant from the second port to the first port via a first fluid path;
a second coolant loop separate from the first coolant loop and comprising a first pump, an energy storage system (ESS), and a high-voltage heater; and
a third coolant loop separate from the first and second coolant loops, the third coolant loop comprising a second pump and an electrical drive system (EDS);
wherein the first coolant loop is interconnectable with at least one of the second coolant loop and the third coolant loop via a first valve, the second coolant loop is interconnectable with the third coolant loop via a first four-way valve, the first coolant loop is interconnectable with the chiller via a chiller fluid path, and at least one of the second coolant loop and the third coolant loop is interconnectable with the chiller; and
a refrigerant system separate from the coolant system, the refrigerant system comprising:
a condenser; and
an internal heat exchanger interconnectable with the condenser and the chiller.

2. The thermal management system of claim 1, wherein the refrigerant system further comprises:
a first heating, ventilation, and air conditioning (HVAC) system interconnectable with the internal heat exchanger.

3. The thermal management system of claim 2, wherein the refrigerant system further comprises:
a second HVAC system interconnectable with the internal heat exchanger.

4. The thermal management system of claim 3, wherein the refrigerant system further comprises:
a second four-way valve disposed between the internal heat exchanger and the condenser, comprising a first port, a second port, a third port, and a fourth port, and wherein one outlet of the internal heat exchanger is interconnectable with the condenser via the first and second ports of the second four-way valve.

5. The thermal management system of claim 4, wherein the third port of the second four-way valve is interconnectable with one inlet of the internal heat exchanger, and wherein the fourth port of the second four-way valve is interconnectable with an inner condenser of the first HVAC system.

6. The thermal management system of claim 5, wherein the first valve is configured to route the coolant from the first coolant loop into the second coolant and the third coolant loop.

7. The thermal management system of claim 6, wherein coolant exiting the ESS enters the first four-way valve and is directed to an exit side of the third coolant loop, and wherein coolant exiting the EDS and the coolant exiting the ESS is routed to the radiator in the first coolant loop.

8. The thermal management system of claim 5, wherein the first valve is configured to route the coolant from the first coolant loop into the third coolant loop without routing the coolant from the first coolant loop into the second coolant loop, wherein coolant exiting the EDS is routed to the radiator in the first coolant loop, and wherein any coolant or refrigerant is prevented from flowing through the chiller.

9. The thermal management system of claim 5, wherein the first coolant loop is separated from the second and third coolant loops, wherein coolant is pumped across the ESS and the coolant exiting the ESS is routed to an exit side of the EDS and split between a first route through the chiller and toward an inlet side of the ESS and a second route through the EDS flowing in a direction from the exit side of the EDS to an inlet side of the EDS across the second pump and toward the first valve, and wherein the first valve is configured to route a portion of the coolant from the EDS back into the second coolant loop at the inlet side of the ESS.

10. The thermal management system of claim 5, wherein the first HVAC system further comprises a first fan, a first evaporator, and a first positive temperature coefficient heater, wherein an other outlet of the internal heat exchanger is interconnectable with the first evaporator via a refrigerant line, wherein the second HVAC system comprises a second fan, a second evaporator, and a second positive temperature coefficient heater, wherein the other outlet of the internal heat exchanger is interconnectable with the second evaporator via a refrigerant line, and wherein the refrigerant line is interconnectable with the chiller.

11. An electric vehicle comprising:
an energy storage system (ESS) comprising a battery;
an electrical drivetrain system (EDS) comprising at least one motor, the EDS powered by the ESS; and
a thermal management system, the thermal management system comprising:
a chiller;
a coolant system, comprising:
a first coolant loop comprising a radiator having a first port and a second port, the first coolant loop configured to route coolant from the second port to the first port via a first fluid path;
a second coolant loop separate from the first coolant loop and comprising a first pump, the ESS, and a high-voltage heater; and
a third coolant loop separate from the first and second coolant loops, the third coolant loop comprising a second pump and the EDS;
wherein the first coolant loop is interconnectable with at least one of the second coolant loop and the third coolant loop via a first valve, the second coolant loop is interconnectable with the third coolant loop via a first four-way valve, the first coolant loop is interconnectable with the chiller via a chiller fluid path, and at least one of the second coolant loop and the third coolant loop is interconnectable with the chiller; and
a refrigerant system separate from the coolant system, the refrigerant system comprising:
a condenser; and
an internal heat exchanger interconnectable with the condenser and the chiller.

12. The electric vehicle of claim 11, wherein the refrigerant system further comprises:
a first heating, ventilation, and air conditioning (HVAC) system interconnectable with the internal heat exchanger.

13. The electric vehicle of claim 12, wherein the refrigerant system further comprises:
a second HVAC system interconnectable with the internal heat exchanger.

14. The electric vehicle of claim 13, wherein the refrigerant system further comprises:
a second four-way valve disposed between the internal heat exchanger and the condenser, comprising a first port, a second port, a third port, and a fourth port, and wherein a first outlet of the internal heat exchanger is interconnectable with the condenser via the first and second ports of the second four-way valve.

15. The electric vehicle of claim 14, wherein the third port of the second four-way valve is interconnectable with a first inlet of the internal heat exchanger, and wherein the fourth port of the second four-way valve is interconnectable with an inner condenser of the first HVAC system.

16. The electric vehicle of claim 15, wherein the first valve is configured to route the coolant from the first coolant loop into the second coolant and the third coolant loop.

17. The electric vehicle of claim 16, wherein coolant exiting the ESS enters the first four-way valve and is directed to an exit side of the third coolant loop, and wherein coolant exiting the EDS and the coolant exiting the ESS is routed to the radiator in the first coolant loop.

18. The electric vehicle of claim 15, wherein the first valve is configured to route the coolant from the first coolant loop into the third coolant loop without routing the coolant from the first coolant loop into the second coolant loop, wherein coolant exiting the EDS is routed to the radiator in the first coolant loop, and wherein any coolant or refrigerant is prevented from flowing through the chiller.

19. The electric vehicle of claim 15, wherein the first coolant loop is separated from the second and third coolant loops, wherein coolant is pumped across the ESS and the coolant exiting the ESS is routed to an exit side of the EDS and split between a first route through the chiller and toward an inlet side of the ESS and a second route through the EDS flowing in a direction from the exit side of the EDS to an inlet side of the EDS across the second pump and toward the first valve, and wherein the first valve is configured to route a portion of the coolant from the EDS back into the second coolant loop at the inlet side of the ESS.

20. A system for managing thermal energy in an electric vehicle, comprising:
a chiller;
a coolant system configured to extract heat from at least one of an energy storage system (ESS) and an electrical drive system (EDS), the coolant system comprising:
a first coolant loop comprising a radiator having a first port and a second port, the first coolant loop configured to route coolant from the second port to the first port via a first fluid path;
a second coolant loop separate from the first coolant loop and comprising a first pump, the ESS, and a high-voltage heater; and
a third coolant loop separate from the first and second coolant loops, the third coolant loop comprising a second pump and the EDS;
wherein the first coolant loop is interconnectable with at least one of the second coolant loop and the third coolant loop via a first valve, the second coolant loop is interconnectable with the third coolant loop via a first four-way valve, the first coolant loop is interconnectable with the chiller via a chiller fluid path, and at least one of the second coolant loop and the third coolant loop is interconnectable with the chiller; and
a refrigerant system separate from the coolant system and configured to control a temperature of a cabin of the vehicle, the refrigerant system comprising:
a condenser; and
an internal heat exchanger interconnectable with the condenser and the chiller.
